(19) United States
(12) Patent Application Publication
(10) Pub. No.: US 2025/0135723 A1
(43) Pub. Date: May 1, 2025

(54) MICROFLUIDIC-BASED FIBER FORMATION METHODS AND SYSTEMS

(71) Applicant: Aspect Biosystems Ltd., Vancouver (CA)

(72) Inventors: Simon BEYER, Richmond (CA); Samuel WADSWORTH, Vancouver (CA); Jackson HE, Vancouver (CA); Zhensong XU, Vancouver (CA); Usama KHAN, Port Coquitlam (CA); Konrad WALUS, Vancouver (CA); Anoush SEPEHRI, Vancouver (CA); Marita RODRIGUEZ, Vancouver (CA)

(21) Appl. No.: 18/686,755

(22) PCT Filed: Aug. 26, 2022
(86) PCT No.: PCT/IB2022/000493

§ 371 Date: Feb. 26, 2024

Related U.S. Application Data
(60) Provisional application No. 63/238,028, filed on Aug. 27, 2021.

(51) Int. Cl. B29C 64/393; B29C 37/00; B33Y 10/00; B33Y 30/00; B33Y 50/02; G06N 3/045; G06V 10/20; G06V 10/26

(52) U.S. Cl. CPC B29C 64/393; G06N 3/045; G06V 10/255; G06V 10/26; B29C 2037/906; B33Y 10/00; B33Y 30/00; B33Y 50/02

(57) ABSTRACT

Microfluidic-based fiber formation methods and systems employ a computer vision and deep learning system and method to enable contactless sensing, analysis, and monitoring of key operational parameters within microfluidic crosslinking printheads on 3D bioprinters. Embodiments may employ object detection and/or semantic segmentation to facilitate the sensing, analysis, and monitoring. Deep learning can employ convolutional neural networks to localize and analyze the flow of different biological materials within the microchannels as well as to identify the operation of various microfluidic printhead on-chip components that can impact final quality of printed tissues. Printed tissues can include single-material fibers, including hollow filorezbers, as well as more complex coaxially-layered fibers.

### CROSS-REFERENCE TO RELATED APPLICATIONS

The present application claims the benefit of U.S. Provisional Application No. 63/238,028, filed Sep. 7, 2021, and incorporates the entire contents of that provisional application by reference herein.

### TECHNICAL FIELD OF DISCLOSURE

Aspects of the present invention relate to quality control methods and apparatus for monitoring microfluidic crosslinking printhead performance. More particular aspects relate to methods and apparatus for monitoring microfluidic crosslinking performance in a three-dimensional (3D) bioprinting platform. Depending on the printhead used, such a platform can generate either single fibers or coaxial multi-layered hydrogel fibers having discrete fiber core and shell components. Yet more particular aspects relate to a computer vision and machine-learning system providing real time visual images of a printhead nozzle, as well as of fibers being formed within the nozzle, in order to quantify geometrical features of the fibers, such as fiber diameter and concentricity of fiber core and shell.

### BACKGROUND

Cell-loaded fibers (normally comprising a core and a shell) are the building blocks of 3D bioprinted tissues. Specific and consistent fiber architectures are required to maintain therapeutic cell viability, tissue function, and protection from the immune system of the host into which the tissues are implanted.

One aspect of fiber architecture takes into account diffusion of oxygen and nutrients into internal cell-containing regions of the fiber. Such diffusion can be a function of thickness of the material in the fiber's shell. A thicker shell can result in a significant drop in oxygen and nutrients and starvation of the therapeutic cells, cell death, and ultimately loss of function. Accordingly, it is important to maintain shell dimensions below a certain thickness, in order to ensure cell viability and function. On the other hand, it can also be important to maintain shell dimensions above a certain thickness, in order to protect a cell payload from host immune attack. These two competing dimensions form a shell thickness window that provides both immune protection, and ensures maintenance of cell function. The window can be very narrow.

In addition to concentricity of a fiber's core and shell, overall fiber diameter may be relevant to the ability of a host to accept the fiber. Fibers with diameters under 1 mm can trigger a stronger fibrotic response, making maintenance of fiber diameter above 1 mm desirable to reduce unwanted fibrosis. Consistent overall fiber diameter during tissue manufacture is also important. A bioprinted tissue will consist of multiple layers. Without sufficient control of fiber diameter, each layer of the resulting tissue can be uneven. Moreover, repetition of the unevenness can compound errors in fiber thickness. As a result, the overall macro-structure of a bioprinted tissue can lose fidelity and can suffer from reduced mechanical integrity and function. Thus, it can be appreciated that concentricity of core and shell, and overall fiber diameter, need to be consistent in order for a bioprinted tissue to be reliable enough for clinical use.

Unfortunately, however, misconcentricity can arise during bioprinting of coaxial fibers for a variety of reasons, and manufacture of printheads for producing such fibers is one source of the problem. In particular, the conventional manufacturing of such printheads requires bonding multiple stacks of layers, for example, transparent polydimethylsiloxane (PDMS) or glass layers. Poor alignment of the layers during bonding can result in poor alignment of the channels and valves, and poor channel and/or valve alignment in turn can adversely influence material flow during fiber formation, and can lead to a lack of concentricity. Another consideration is that biomaterial properties, such as viscosity under changing pressure during printing, can influence not only fiber diameter but also the alignment of the central axes of the fiber's core (middle) and shell (outside).

Still further, material anomalies such as bubbles and, in the case of cell-loaded fibers, clusters of cells can also result in misconcentricity. FIGS. 1A-1F show respective cross sectional views taken along the lengths and diameters of representations of fibers with different respective locations of a core inside a shell of a fiber. In FIG. 1A, a fiber 100 has a central axis 110, a core 120, a core outer edge 130, a shell 140, and a shell outer edge 150. Corresponding numbering applies to FIGS. 1B-1F. FIG. 1A is an example of a fiber with concentricity between core 120 and shell 140. FIGS. 1B-1F are different examples of misconcentricity.

It would be desirable to provide a system that not only monitors fiber production, but also provides a feedback mechanism for correcting identified misconcentricity during microfluidic crosslinking. It further would be desirable to provide a system that teaches a 3D bioprinting system to produce consistently concentric fibers with consistent core and shell diameters to facilitate production of 3D tissue that will be accepted.

### SUMMARY

The present invention addresses the foregoing problems in the art by integrating computer vision and deep learning into a three-dimensional (3D) bioprinting platform, thereby enabling direct monitoring of operation and flow of a plurality of different materials within a microfluidic crosslinking printhead including, e.g., cell-laden hydrogels and other cross-linkable materials. In embodiments, the invention comprises one or more cameras as part of a computer vision system and method, to image the simultaneous flow of a plurality of different materials within a microfluidic crosslinking printhead. Further embodiments include a light emitting diode (LED) or LED array for each of the cameras, to illuminate transparent features of the microfluidic printhead and the fibers within. In embodiments, one or more mirrors may be substituted for one of the cameras.

Embodiments of the invention enable contactless sensing of the characteristics of the biomaterials as they flow out of microfluidic crosslinking devices to form fibers for 3D bioprinting. Embodiments also enable automated analyses, which in turn enable derivation of quantitative measures of printed fiber properties. These measures can serve as quality control and/or quality assurance parameters.

Aspects of the invention integrate computer vision and artificial intelligence/deep learning/machine-learning into a 3D bioprinting platform to directly monitor the operation and simultaneous flow of different materials, including one or more hydrogel materials, within the microfluidic crosslinking device. In embodiments, the inventive system enables contactless sensing of fiber formation. Embodiments of the inventive system provide automated analyses in order to derive quantitative measures of printed fiber properties as quality control/quality assurance parameters. In some embodiments, such quantitative measures include real-time high-level quantitation of biological material (e.g., cells) throughout a fiber during printing thereof, for qualitative assessment of fiber quality in terms of the consistency of biological material throughout the printed fiber. In some embodiments, such quantitative measures include real-time high-level quantitation of other objects within a material flow, for example microparticles.

In embodiments, different machine-learning tools may be employed. For example, convolutional neural networks (CNN) can be used for object detection. As another example, semantic segmentation can be used to monitor and analyze different properties of the printhead and resulting fiber during printing.

In embodiments, outputs of the various machine-learning tools can be fed back in real-time to the 3D bioprinting platform in order to adjust the pressure and/or displacement and subsequent flow of materials within the microfluidic channels of the printhead to correct for diameter and/or misconcentricity, thus enabling consistent production of quality fibers and minimizing the loss of expensive biomaterial and cell inputs in bioprinted fibers.

In embodiments, the material flow comprises at least one cross-linkable material, and preferably at least one hydrogel, optionally further comprising at least one biological material, e.g. a cell population in a biocompatible material. In embodiments, the cell population is selected from the group comprising or consisting of a single-cell suspension, cell aggregates, cell spheroids, cell organoids, or combinations thereof. In embodiments, the material flow comprises micro-particles.

In embodiments, the cell population comprises cells from endocrine and exocrine glands selected from the group consisting of pancreas, liver, thyroid, parathyroid, pineal gland, pituitary gland, thymus, adrenal gland, ovary, testis, enteroendocrine cells, stem cells, stem cell-derived cells or cells engineered to secrete a biologically active agent of interest. In embodiments, the cell population releases cell-derived extracellular vesicles in the form of exosomes containing a therapeutic protein or nucleic acid. In embodiments, the biocompatible material is selected from alginate, collagen, decellularized extracellular matrices, hyaluronic acid, PEG, fibrin, gelatin, GEL-MA, silk, chitosan, cellulose, PCL, PLA, POEGMA, and combinations thereof.

In some embodiments, the microfluidic printheads may employ pressure to control material flow in fiber production. In other embodiments, the microfluidic printheads may employ material displacement to control material flow in fiber production.

Among other things, embodiments of the invention enable the real-time inspection of various geometrical features of the multi-layered fibers being produced. Among the resulting effects is the avoidance of a need to incorporate costly and/or complex pressure sensors or other microelectromechanical systems (MEMS) based technology into the printheads to monitor valves and channel pressures and to detect defects, anomalies and/or faults in processes and printed fibers.

In one aspect, the invention provides a microfluidic crosslinking printhead material flow sensing system comprising: a microfluidic crosslinking printhead: a material flow comprising at least one cross-linkable material: a camera system to monitor material flow through the microfluidic crosslinking printhead and to provide streaming images of the material flow; and a computer system to determine physical properties of a printed fiber, resulting from crosslinking created by the material flow, by analyzing the material flow as represented in the streaming images: wherein the computer system comprises a machine-learning based system that compares the streaming images of the material flow to user-established material flow parameters corresponding to the physical properties of a printed fiber within a predetermined tolerance, and records the material flow parameters for the material flow, and results of the comparison.

In embodiments, the microfluidic crosslinking printhead comprises one or more transparent channels, and the camera system monitors material flow through at least one of the one or more transparent channels, preferably wherein the microfluidic crosslinking printhead comprises a transparent nozzle or dispensing channel.

In embodiments, the camera system comprises a first camera positioned at a first angle with respect to the at least one of the one or more transparent channels and a second camera positioned at a second, different angle with respect to the at least one of the one or more transparent channels. In embodiments, the first camera and the second camera are at right angles with respect to each other.

In alternative embodiments, the camera system comprises a camera and a plurality of mirrors, the mirrors positioned to provide a first view and a second, different view with respect to the at least one of the one or more transparent channels, the camera receiving images of the first and second views. In embodiments, the second view is orthogonal to the first view. In embodiments, the plurality of mirrors comprise three mirrors, arranged to provide the first and second views. In embodiments, the plurality of mirrors comprise two mirrors, wherein one of the mirrors is rotatable to provide the first and second views alternately to said camera.

In an exemplary embodiment, the microfluidic system comprises a plurality of transparent channels and the camera system comprises an equal plurality of pairs of first and second cameras, each first and second camera in each pair being positioned at right angles with respect to each other, and each of the plurality of pairs of first and second cameras to monitor material flow through a different respective one of the plurality of transparent channels.

In embodiments, the machine-learning based system identifies one or more deviations in the material flow from the user-established material flow parameters. In embodiments, and responsive to the identified one or more deviations, the machine-learning based system identifies whether adjusting the material flow parameters is necessary. In embodiments, the machine-learning based system adjusts the material flow parameters in response to cumulative deviations exceeding a predetermined amount. In embodiments, the machine-learning based system adjusts the material flow parameters in order to maintain physical properties of the printed fiber within a predetermined tolerance. In embodiments, the physical properties comprise a diameter of the bioprinted fibers. In embodiments, the physical properties comprise a concentricity of layers within the bioprinted fibers.

In embodiments, the machine-learning based system performs object detection and/or semantic segmentation of the streaming images of the material flow. In embodiments, the object detection and/or semantic segmentation enables detection of location of one or more objects within the material flow. In embodiments, the object detection and/or semantic segmentation enables visual estimation of a shape and/or size of the one or more objects within the material flow. In embodiments, the object detection and/or semantic segmentation enables visual estimation of a general amount and/or distribution of biological material (e.g., cell population) within the material flow.

In embodiments, the microfluidic device comprises a three-dimensional (3D) bioprinting printhead, and the system comprises a 3D bioprinting system to produce bioprinted fibers. In embodiments, the 3D bioprinting printhead comprises a plurality of channels to selectively provide a respective plurality of materials for the material flow.

In embodiments, the at least one cross-linkable material comprises a hydrogel. In embodiments, the material flow further comprises at least one biological material; preferably wherein said at least one biological material comprises a cell population. In embodiments, the cell population is selected from the group comprising or consisting of a single-cell suspension, cell aggregates, cell spheroids, cell organoids, or combinations thereof. In embodiments, the material flow further comprises microparticles. In embodiments, the material flow further comprises dyes, pigments or colloids. In embodiments, the presence of cells in the material flow acts as a contrast agent to facilitate measurement of physical properties of the bioprinted fibers.

In exemplary embodiments, cell-laden biomaterials flow through the respective channels to produce the bioprinted fibers. In embodiments, the bioprinted fibers are coaxially layered hydrogel fibers. In embodiments, the bioprinted fibers comprise a core hydrogel material, and a shell hydrogel material around the core hydrogel material, wherein the core hydrogel material is disposed concentrically within the shell hydrogel material within the predetermined tolerance.

In one embodiments, the computer system uses the results of the comparison to control the material flow by adjusting displacement of material within the microfluidic device. In embodiments, the system further comprises a displacement controller responsive to the results of the comparison to control the material flow and displacement of material through the microfluidic device during printing of the printed fiber.

In another embodiment, the computer system uses the results of the comparison to control the material flow by adjusting pressure of material flow within the microfluidic device. In embodiments, the system further comprises a pressure controller responsive to the results of the comparison to control the material flow and pressures through the microfluidic device during printing of the printed fiber.

In embodiments, the machine-learning based system is selected from the group consisting of a convolutional neural network (CNN), a long short term memory (LSTM) network, a recurrent neural network (RNN), a recurrent convolutional neural network (RCNN) or a combination of an RNN and a CNN. In embodiments, the machine-learning based system comprises a graphics processing unit (GPU).

In embodiments, the system further comprises a light emitting diode (LED) or an LED array to illuminate one or more of the transparent channels. In embodiments, the system further comprises one LED or LED array for each of the cameras respectively. In some embodiments, wherein each LED or LED array is positioned behind a respective camera. In alternative embodiments, each LED or LED array is positioned on an opposite side of a transparent channel from the respective camera.

In another aspect, the invention provides a method for monitoring material flow through a crosslinking microfluidic printhead, said method comprising: obtaining, using a camera system, streaming images of material flow through a microfluidic crosslinking printhead: determining physical properties of a printed fiber, resulting from crosslinking created by the material flow, by analyzing the material flow as represented in the streaming image, the determining comprising, using a machine-learning based system, comparing the streaming images of the material flow to user-established material flow parameters corresponding to the physical properties of a printed fiber within a predetermined tolerance; and responsive to the determining, controlling the material flow to maintain the physical properties of the printed fiber within the predetermined tolerance. Preferably, the obtaining comprises obtaining the streaming images through one or more transparent channels of the microfluidic crosslinking printhead.

In embodiments, the obtaining comprises positioning a first camera in the camera system at a first angle with respect to the at least one of the one or more transparent channels, and a second camera in the camera system at a second, different angle with respect to the at least one of the one more transparent channels. In embodiments, the positioning comprises positioning the first camera and the second camera at right angles with respect to each other.

In alternative embodiments, the obtaining comprises positioning a camera in the camera system to provide a first view with respect to the at least one of the one or more transparent channels and positioning a plurality of mirrors to provide a second, different view with respect to the at least one of the one or more transparent channels. In embodiments, the second view is orthogonal to the first view. In embodiments, the positioning comprises positioning three mirrors to provide the second view. In embodiments, the positioning comprises positioning two mirrors to provide the first and second views alternately to said camera, wherein one of the mirrors is rotatable to provide the first and second views alternately to said camera.

In embodiments, the comparing comprises identifying one or more deviations in the material flow from the user-established material flow parameters. In embodiments, the method further comprises determining whether the one or more deviations in the material flow exceeds a predetermined amount, and adjusting one or more of the user-established material flow parameters in response to the determining to maintain the physical properties of the printed fiber within the predetermined tolerance. In embodiments, the physical properties comprise a diameter of the bioprinted fibers. In embodiments, the physical properties comprise a concentricity of the bioprinted fibers.

In embodiments, the determining further comprises, using the machine-learning based system, performing object detection and/or semantic segmentation of the streaming images of the material flow. In embodiments, the object detection and/or semantic segmentation enables detection of location of one or more objects within the material flow. In embodiments, the object detection and/or semantic segmentation enables visual estimation of a shape and/or size of the one or more objects within the material flow. In embodiments, the object detection and/or semantic segmentation enables visual estimation of a general amount and/or distribution of biological material (e.g., cell population) within the material flow.

In embodiments, the obtaining comprises obtaining streaming images through one or more transparent channels in a three-dimensional (3D) bioprinting printhead in the microfluidic device, the 3D bioprinting printhead producing bioprinted fibers. In embodiments, the monitoring comprises monitoring a plurality of channels within the 3D bioprinting printhead, the plurality of channels to selectively provide a respective plurality of materials for the material flow.

In embodiments, the at least one cross-linkable material comprises a hydrogel. In embodiments, the material flow further comprises at least one biological material; preferably wherein said at least one biological material comprises a cell population. In embodiments, the cell population is selected from the group comprising or consisting of a single-cell suspension, cell aggregates, cell spheroids, cell organoids, or combinations thereof. In embodiments, the material flow further comprises microparticles. In embodiments, the material flow further comprises dyes, pigments or colloids. In embodiments, the presence of cells in the material flow acts as a contrast agent to facilitate measurement of physical properties of the bioprinted fibers.

In exemplary embodiments, cell-laden biomaterials flow through the respective channels to produce the bioprinted fibers. In embodiments, the bioprinted fibers are coaxially layered hydrogel fibers. In embodiments, the bioprinted fibers comprise a core hydrogel material, and a shell hydrogel material around the core hydrogel material, wherein the core hydrogel material is disposed concentrically within the shell hydrogel material within the predetermined tolerance.

In one embodiment, controlling the material flow comprises controlling displacement of material within the microfluidic device. In another embodiment, controlling the material flow comprises controlling pressure of the material flow within the microfluidic device.

In embodiments, the machine-learning based system is selected from the group consisting of a convolutional neural network (CNN), a long short term memory (LSTM) network, a recurrent neural network (RNN), a recurrent convolutional neural network (RCNN) or a combination of an RNN and a CNN. In embodiments, the machine-learning based system comprises a graphics processing unit (GPU).

In embodiments, the method further comprises positioning a light emitting diode (LED) or an LED array to illuminate one or more of the transparent channels. In embodiments, the method further comprises positioning one LED or LED array for each of the cameras respectively. In some embodiments, the method comprises positioning each LED or LED array behind a respective camera. In alternative embodiments, the method comprises positioning each LED or LED array on an opposite of a transparent channel from the respective camera.

In embodiments, the method further comprises identifying one or more defects in the material flow, e.g., a clog and/or bubble, by analyzing the material flow as represented in the streaming images using the machine-learning based system to perform object detection and/or semantic segmentation on the streaming images.

In embodiments, the method further comprises providing a general amount and/or distribution of one or more objects within the material flow using the machine-learning based system to perform object detection and/or semantic segmentation on the streaming images, preferably wherein the one or more objects comprises biological materials, e.g., cells.

In embodiments, the method further comprises analyzing whether core hydrogel material is disposed concentrically in shell hydrogel material.

### BRIEF DESCRIPTION OF THE DRAWINGS

The accompanying drawings, which are incorporated herein and form a part of the specification, illustrate embodiments of the present disclosure and, together with the description, further serve to explain the principles of the disclosure and to enable a person skilled in the relevant art to make and use the disclosure.

FIGS. 1A-1F show cross-sectional views of different fibers:

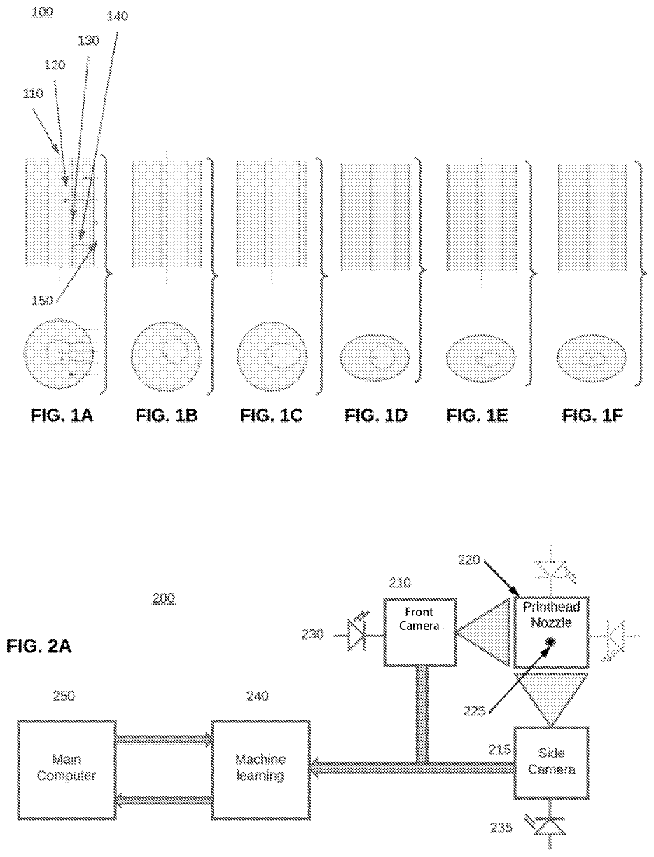

FIG. 2A is a high level block diagram of a system according to one or more embodiments, and FIGS. 2B to 2D are more detailed views of the camera vision system according to the one or more embodiments:

FIG. 3 shows examples of displays for viewing outputs of the system of FIG. 2:

FIGS. 4A and 4B show valve arrangements for provision of materials to be used in producing fibers according to one or more embodiments:

FIG. 5 is a high level flow chart for operation of one or more embodiments:

FIGS. 6A-6D show pictures and graphs relating to neural network training for purposes of performing case studies:

FIGS. 7A and 7B show training results:

FIGS. 8A-8H show pictures and plots relating to a case study:

FIG. 8I shows exemplary images of a clog interfering with fiber generation:

FIG. 8J shows exemplary images of a bubble interfering with fiber generation:

FIGS. 9A and 9B show training results in connection with the case study depicted in FIGS. 8A-8H:

FIG. 10A-10I show pictures and plots relating to a further case study:

FIGS. 11A and 11B show training results in connection with the case study depicted in FIGS. 10A-I;

FIGS. 12A-12B are screen shots of displays for viewing outputs of the system of FIG. 2, taken at two different timepoints and depicting the controlling of a shell diameter of a bioprinted fiber to a desired diameter;

FIG. 13 shows screen shots (left) and corresponding high-level quantitation of biological material (right) from three time points (0 seconds, 30 seconds, 90 seconds) of a video recording of a bioprinted fiber during printing thereof:

FIG. 14 shows images of a segment of a fiber containing biological material similar to that shown at FIG. 13, in the context of a portion of a whole bioprinted fiber recontructed from a video recording of the fiber during printing thereof; and

FIG. 15A shows an image of a core and shell, and FIGS. 15B-15E show images of different core positions within the shell.

### DETAILED DESCRIPTION

Certain illustrative aspects of the systems, apparatuses and methods according to the present invention are described herein in connection with the following description and the accompanying figures. These aspects are indicative, however, of but a few of the various ways in which the principles of the invention may be employed and the present invention is intended to include all such aspects and their equivalents. Other advantages and novel features of the invention may become apparent from the following detailed description when considered in conjunction with the figures.

In the following detailed description, numerous specific details are set forth in order to provide a thorough understanding of the invention. In other instances, well known structures, interfaces and processes have not been shown in detail in order not to unnecessarily obscure the invention. However, it will be apparent to one of ordinary skill in the art that those specific details disclosed herein need not be used to practice the invention and do not represent a limitation on the scope of the invention, except as recited in the claims. It is intended that no part of this specification be construed to effect a disavowal of any part of the full scope of the invention. Although certain embodiments of the present disclosure are described, these embodiments likewise are not intended to limit the full scope of the invention.

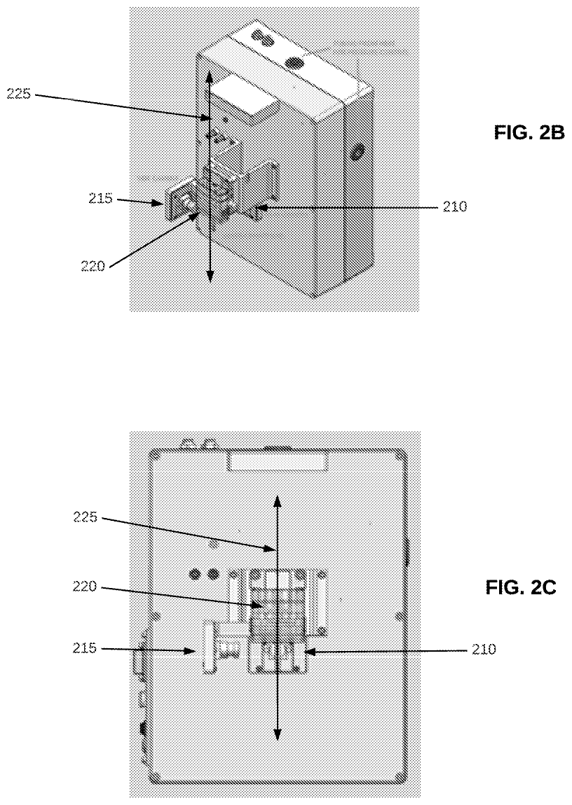

FIG. 2A shows a high level block diagram of elements that can be integrated into embodiments of the invention. The elements in FIG. 2 may be integrated into a 3D bioprinter platform. One example is the RXI™ bioprinter from Aspect Biosystems. Looking more closely at FIG. 2A, two cameras 210, 215 which form part of a computer vision system may be placed respectively to the rear of and to one side of a transparent printhead nozzle 220, perpendicular to an axis 225 running vertically through the nozzle (in FIG. 2A, the axis 225 is magnified for ease of viewing) to enable real time viewing of 3D printing of fibers by providing streaming video images.

In the present application, “transparent” means sufficiently translucent to enable light to pass through the microchannel and/or nozzle structure, and to enable viewing of materials within the microchannel and/or the nozzle. In the case of multilayer fibers comprising a core and one or more shells, the nozzle is sufficiently transparent to enable distinguishing visually between the core and the one or more shells.

In an embodiment, the cameras 210, 215 are positioned at a 90 degree angle with respect to each other. Depending on the nozzle arrangement and configuration, either alone or within a bioprinting system, different angles may be acceptable or even preferable. In addition, according to different embodiments, resolution of the cameras 210, 215 can vary. In some implementations, 480p resolution may be sufficient. In other implementations, higher resolutions may be desirable. Higher resolutions would be anticipated in the future. Interlaced video may provide acceptable video quality in some implementations.

In an embodiment, the cameras 210, 215 may support 4K (2160×3840 pixels) resolution at 30 FPS. Other resolutions and frame speeds may be appropriate. Embodiments may employ an M12 lens (where the “M12” designation refers to a size of the mount on the lens) with a 11.9 mm focal length with 8 MP construction. M12 is a type of lens that has different focal lengths and can have different f-stop values. Other lenses with different mount sizes (e.g. M4 to M10) may be suitable. Also, other types of mounts, such as C-mounts or CS-mounts, may be suitable. Other constructions besides 8 MP also may be appropriate.

FIG. 2B shows a perspective view of an arrangement of cameras 210, 215 relative to the printhead nozzle 220, and also shows axis 225 running vertically through the printhead nozzle 220. FIG. 2C shows a face-on view of the same arrangement.

In some embodiments, the cameras are positioned such that each lens may be approximately 26 mm from the center of the printhead's nozzle to optimize focus and magnification within the field of view. Different focal length lenses with different f-stops and different fields of view may enable different positioning. In one configuration, the two cameras are placed at right angles to each other on two sides of the nozzle, to yield two orthogonal views of the nozzle. In one embodiment, additional lighting may be provided to illuminate the nozzle, either from behind each camera or from an opposite side of each camera, or both. The lighting may comprise a light emitting diode (LED) or an LED array 230 for front camera 210, and LED or LED array 235 for side camera 215. The LED or the LED array 230 may be positioned on axis with the camera lens, to project light (in an embodiment, white light) to illuminate the nozzle. The light may be passed through a narrow circular or polygonal hole, or a slit (not shown), to help to focus the light more specifically where the imaging is to be done. With these kinds of optics arrangements, edges of the inner nozzle (the inner diameter, within which the fibers are formed), as well as the fiber being produced (in the case of a concentric fiber, the shell and the core), may be visible in the camera views.

In an embodiment, one or more mirrors may be arranged to provide the desired views to a camera, which may be any of exemplary cameras 210, 215 described herein. In FIG. 2D, light sources 270, 275, which may be LED sources, cause light to pass through nozzle 220. Light source 270 provides light (dotted line) that strikes a mirror 252, is reflected to a further mirror 256, and then is reflected to camera 260 comprising camera structure 262 and lens 264. Light source 275 provides light (solid line) that strikes another mirror 254, and is reflected through mirror 256 (which may be a dichroic mirror) to arrive at camera 260. In an embodiment, the mirrors and light sources are arranged to pass light through nozzle 220 at right angles.

With two orthogonal images of the printhead nozzle 220 and of the fiber being produced inside the nozzle, it is possible to obtain three values:
1) With a known inner nozzle diameter and a known lens and distance from the nozzle center, it is possible to measure the number of pixels within the inner nozzle diameter, and thus determine the horizontal distance that each pixel represents.
2) Assuming that a cross-section of the fiber is elliptical, it is possible to take the vector sum of the fiber diameter and/or the fiber core diameter from the two orthogonal views and determine the upper and lower bounds of the true diameter of the fiber and the core.
3) With information about location of the left and right edges of the fiber and the core, it is possible to continuously calculate the degree of concentricity of the core relative to the overall fiber by taking the ratio of the core's center relative to the overall fiber diameter. Using the same principle, it is possible to continuously calculate the concentricity of the fiber or the core relative to the inner nozzle as well.

Moreover, with a defined flow rate and measured fiber diameter it is also possible to calculate the fiber speed, which is another important piece of feedback for optimizing print speed. If the nozzle moves too fast or too slow in relation to the stage, the fidelity of the fiber and the printed structure will be negatively impacted.

A machine-learning module 240 receives data streams or captured images from front camera 210 and side camera 215. In embodiments, the module 340 may employ one or a plurality of GPU processors with pluralities of cores to facilitate the necessary calculations for a machine-learning system to perform rapid computational analysis of data streams or captured images, and training of the model that provides feedback to control material flow in the bioprinting system. In embodiments, the model training may involve testing and validation to facilitate optimization and inference by the model being trained.

Machine-learning module 240 may interact with a computer system (main computer) 250 which may perform a number of user-interactive functions and also system-interactive functions. For user interaction, the computer system 250 may provide an appropriate graphical display and graphical user interface for interaction with various other components such as the cameras 210, 215, the machine-learning module, and the bioprinting system itself (of which the printhead nozzle 220 of course is a part).

Part of the control that computer system 250 performs involves monitoring of fiber concentricity and access to control systems in the bioprinting system to adjust material flow, whether by control of pressure in various microfluidic printhead channels to be discussed below, or by control of displacement of material through the channels. In embodiments, control may involve toggling on or off or otherwise adjusting opening and closing of pneumatic valves on a printhead. In embodiments, part of the control that computer system 250 performs involves object recognition and/or semantic segmentation. In embodiments, the object detection and/or semantic segmentation enables visual estimation of a general amount and/or distribution of biological material (e.g., cell population) within a material flow.

Computer system 250 also may enable reading of printhead-specific information viewing of the respective feeds from the cameras 210, 215 to enable recording and/or loading of one or both of the feeds, and adjust camera/video parameters such as contrast, tint, brightness, and sharpness, among others.

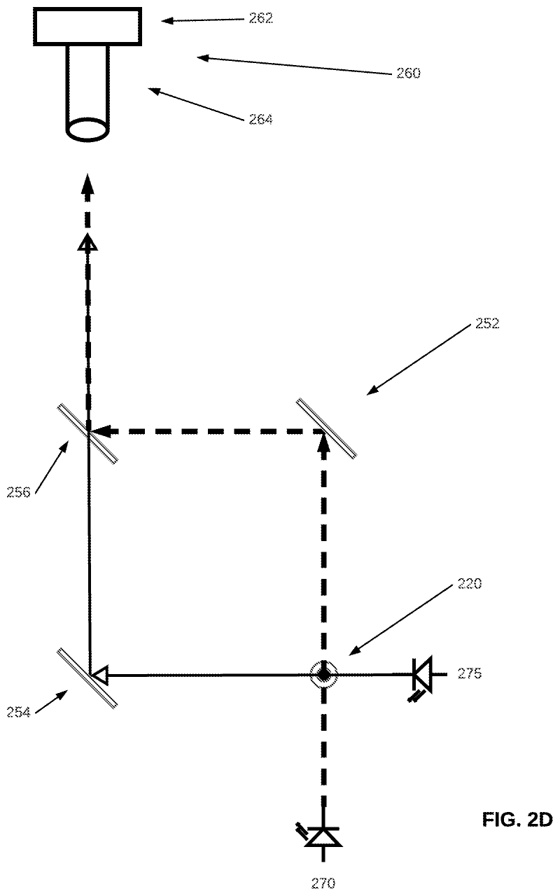

FIG. 3 shows representative images of displays according to an embodiment of software and accompanying user interface to enable the concentricity monitoring and control system to adjust the microfluidic channel valves and pressures. In embodiments, the display may show live streaming of the video camera images, automated segmentation results, fiber property and concentricity test measurements, and/or measured parameters pertaining to recognized objects (e.g., biological material). In other embodiments, channel conditions, such as a clog, or bubbles, or instability might be displayed. Some conditions might suggest remedial actions for the users, such as agitating bioink to reduce clumping, or purging the channel to remove a bubble. Other display possibilities may include quantitative information about fiber properties. In an embodiment, a confidence interval rating from the machine-learning system can be displayed, indicating a degree of certainty in segmentation or classification of a particular image.

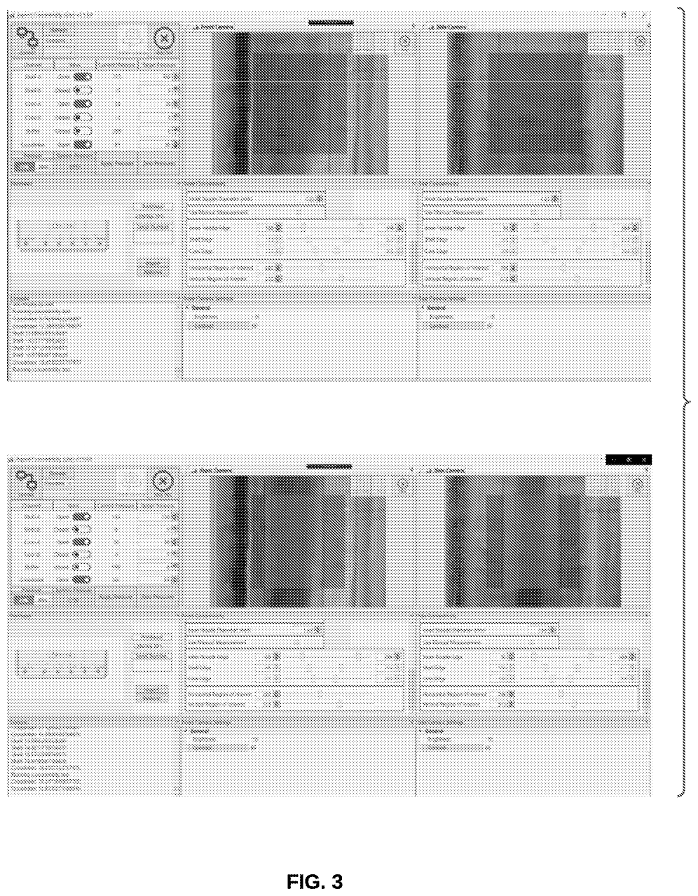

FIG. 4A shows an exemplary configuration of one kind of printhead 400 which may provide control over separate hydrogels containing different biomaterials or cells, thus enabling generation of different single-material fibers during bioprinting. The Aspect Biosystems DUO™ printhead has corresponding structure to what FIG. 4A shows. In FIG. 4A, different materials are provided respectively through line 410 (to which valve 412 is connected) and line 420 (to which valve 422 is connected). Buffer may be provided through line 430 (to which valve 432 is connected). Crosslinking material may be provided through line 440 (to which valve 442 is connected). Bioprinted fiber is produced at outlet 445.

FIG. 4B shows an exemplary configuration of another kind of printhead 450 which may provide control over formation of coaxially-layered hydrogel fibers, the fibers consisting of a core and a shell constituted respectively by different hydrogel materials with or without cells. The Aspect Biosystems CENTRA™ printhead has corresponding structure to what FIG. 4B shows. In FIG. 4B, core materials may be provided through lines 460, 465 (to which respective valves 462, 467 are connected). Shell materials may be provided through lines 470, 475 (to which respective valves 472, 477 are connected). Buffer material may be provided through line 480 (to which valve 482 is connected). Crosslinking material may be provided through line 490 (to which valve 492 is connected). Bioprinted coaxial fiber is produced at outlet 495.

Referring back to FIG. 2A, rear and side cameras 210, 215 may be directed at or before outlets 445, 495 in FIGS. 4A and 4B to provide video of the fibers as they are being produced.

Depending on the type of material flow control being used, either a pressure controller or a displacement controller can enable control of biomaterial flow and pressures or displacements through a printhead during 3D printing. Referring to FIGS. 4A and 4B, pressures of biomaterials through lines 410, 420, 460, 465, 470, and 475 may be controlled in various ways, including through control of valves 412, 422, 462, 467, 472, and 477 associated with the lines.

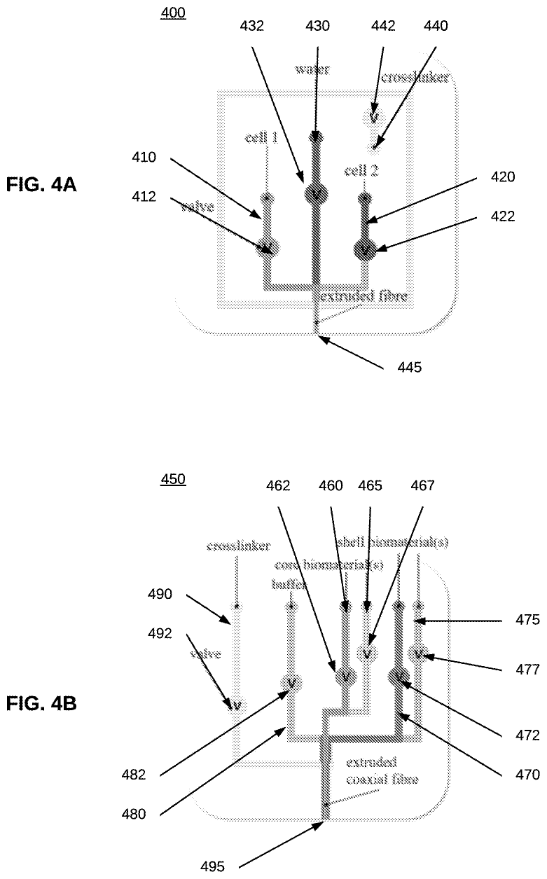

FIG. 5 is a high level flow chart for the implementation and use of computer vision and machine-learning tools to provide automated feedback control. At 510, the cameras in the computer vision system are controlled to record video images of material passing through a printhead nozzle. These images are obtained through various types of operation of the 3D bioprinting system. To generate data for training sets for the machine-learning model, for example, the system may be operated with known materials and parameters to obtain known results. Other data sets, to be used in testing and evaluation of the trained system, also may be generated.

At 520, the collected data may be separated in the aforementioned training sets and testing/evaluation sets. At 530, focusing on the training sets, features of interest may be labeled, to facilitate focusing on those during training. At 540, appropriately labeled training sets may be applied to a deep learning model to train it, evolving the model to have it produce correct results from the training data. In some deep learning models, forward propagation of results may be used. In other models, back propagation may be used.

In an embodiment, a convolutional neural network (CNN), for example, having a UNET network architecture, may be employed. This kind of network has been known to provide favorable results when handling images of very complex structures that have poorly defined boundaries (for example, in the medical imaging field). With bioprinter nozzles, the ability for a camera vision system to see well through the nozzle to get to the different biomaterials can be more limited. Ordinarily skilled artisans will appreciate that different varieties of CNN, for example, long short term memory (LSTM) networks or recurrent CNN (RCNN), may be employed to good effect. In an embodiment, a recurrent neural network (RNN) may be used alone or in combination with a CNN.

At 550, training results may be analyzed to identify various features of interest, for example, valve location, fiber dimensions, concentricity of fiber cores and fiber shells, and the like. The results then may be classified according to the features of interest, level of accuracy, etc. At 560, the testing/validation sets may be used to evaluate performance of the trained network. At 570, if the model is satisfactory, then at 580 the completed trained model may be deployed. If the model is not satisfactory, then at 575 the training sets may be modified, and control returned to 530 for further training. Modification of training sets will be informed by the nature of the results obtained with the previous training sets.

### Material Flows:

Aspects of the invention include material flows that can be used for printing fiber structures for advantageous use as biomaterials. “Biomaterial” as used herein refers to a natural or synthetic substance that is useful for constructing or replacing tissue, e.g. human tissue with or without living cells. In the field of bioprinting, the term “biomaterial” is often synonymous with the term “bioink.”

The material flow will generally comprise at least one cross-linkable material, e.g., hydrogels including but not limited to, alginate, chitosan, PEGDA, PEGTA, Hyaluronic acid (HA), HAMA, collagen, CollMA, gelatin, gelMA, agarose, gellan, fibrin (fibrinogen), PVA, and the like, or any combination thereof, as well as non-hydrogels including but not limited to, PCL, PLGA, PLA, and the like, or any combination thereof. In preferred embodiments the material flow comprises at least one hydrogel. Non-limiting examples of hydrogels include alginate, agarose, collagen, fibrinogen, gelatin, chitosan, hyaluronic acid-based gels, or any combination thereof. A variety of synthetic hydrogels are known and can be used in embodiments of the systems and methods provided herein. For example, in some embodiments, one or more hydrogels form at least part of the structural basis for three dimensional structures that are printed. In some embodiments, a hydrogel has the capacity to support growth and/or proliferation of one or more cell types, which may be dispersed within the hydrogel or added to the hydrogel after it has been printed in a three dimensional configuration.

In embodiments, a hydrogel is cross-linkable by a chemical cross-linking agent. For example, a hydrogel comprising alginate may be cross-linkable in the presence of a divalent cation such as calcium chloride (CaCl₂)), a hydrogel containing chitosan may be cross-linked using a polyvalent anion such as sodium tripolyphosphate (STP), a hydrogel comprising fibrinogen may be cross-linkable in the presence of an enzyme such as thrombin, and a hydrogel comprising collagen, gelatin, agarose or chitosan may be cross-linkable in the presence of heat or a basic solution.

In embodiments hydrogel fibers may be generated through a precipitation reaction achieved via solvent extraction from the input material upon exposure to a cross-linker material that is miscible with the input material. Non-limiting examples of input materials that form fibers via a precipitation reaction include collagen and polylactic acid (PLA). Non-limiting examples of cross-linking materials that enable precipitation-mediated hydrogel fiber formation include polyethylene glycol (PEG) and alginate. Cross-linking of the hydrogel will increase the hardness of the hydrogel, in some embodiments allowing formation of a solidified hydrogel.

In some embodiments, a hydrogel comprises alginate. Alginate forms solidified colloidal gels (high water content gels, or hydrogels) when contacted with divalent cations. Any suitable divalent cation can be used to form a solidified hydrogel with an input material that comprises alginate. In the alginate ion affinity series Cd2+>Ba2+>Cu2+>Ca2+>Ni2+>Co2+>Mn2+, Ca2+ is the best characterized and most used to form alginate gels (Ouwerx, C. et al., Polymer Gels and Networks, 1998, 6 (5): 393-408). Studies indicate that Ca-alginate gels form via a cooperative binding of Ca2+ ions by poly G blocks on adjacent polymer chains, the so-called “egg-box” model (ISP Alginates, Section 3: Algin-Manufacture and Structure, in Alginates: Products for Scientific Water Control, 2000, International Specialty Products: San Diego, pp. 4-7). G-rich alginates tend to form thermally stable, strong yet brittle Ca-gels, while M-rich alginates tend to form less thermally stable, weaker but more elastic gels. In some embodiments, a hydrogel comprises a depolymerized alginate.

In some embodiments, a hydrogel is cross-linkable using a free-radical polymerization reaction to generate covalent bonds between molecules. Free radicals can be generated by exposing a photoinitiator to light (often ultraviolet), or by exposing the hydrogel precursor to a chemical source of free radicals such as ammonium peroxodisulfate (APS) or potassium peroxodisulfate (KPS) in combination with N,N,N,N-Tetramethylethylenediamine (TEMED) as the initiator and catalyst respectively. Non-limiting examples of photo cross-linkable hydrogels include: methacrylated hydrogels, such as hyaluronic acid methacrylate (HAMA), gelatin methacrylate (GEL-MA) or polyethylene (glycol) acrylate-based (PEG-Acylate) hydrogels, which are used in cell biology due to their inertness to cells. Polyethylene glycol diacrylate (PEG-DA) is commonly used as scaffold in tissue engineering, since polymerization occurs rapidly at room temperature and requires low energy input, has high water content, is elastic, and can be customized to include a variety of biological molecules.

In embodiments, the material flow comprises a non-biodegradable polymer. In examples the input material may be a synthetic polymer, for example polyvinyl acetate (PVA). In embodiments, the material flow may comprise hyaluronic acid (HA).

In embodiments, the material flow comprises microparticles, “Microparticles” as used herein refers to immiscible particles in the range of about 0.1 um to about 100 um that are typically composed of a polymer, a metal, or other inorganic material. They can be symmetrical (e.g. spherical, cubic, etc) although this is not a requirement. Microparticles having an aspect ratio of 2:1 or greater may be considered a microrod or microfibre.

### Additional Components:

Material flows in accordance with embodiments of the invention can comprise any of a wide variety of natural or synthetic polymers that support the viability of living cells, including, e.g., alginate, laminin, fibrin, hyaluronic acid, poly(ethylene)glycol based gels, gelatin, chitosan, agarose, or combinations thereof. In embodiments, the subject compositions are physiologically compatible, i.e., conducive to cell growth, differentiation and communication. In certain embodiments, an input material comprises one or more physiological matrix materials, or a combination thereof. By “physiological matrix material” is meant a biological material found in a native mammalian tissue. Non-limiting examples of such physiological matrix materials include: fibronectin, thrombospondin, glycosaminoglycans (GAG) (e.g., hyaluronic acid, chondroitin-6-sulfate, dermatan sulfate, chondroitin-4-sulfate, or keratin sulfate), deoxyribonucleic acid (DNA), adhesion glycoproteins, and collagen (e.g., collagen I, collagen II, collagen III, collagen IV, collagen V, collagen VI, or collagen XVIII).

Collagen gives most tissues tensile strength, and multiple collagen fibrils approximately 100 nm in diameter combine to generate strong coiled-coil fibers of approximately 10 μm in diameter. Biomechanical function of certain tissue constructs is conferred via collagen fiber alignment in an oriented manner. In some embodiments, an input material comprises collagen fibrils. An input material comprising collagen fibrils can be used to create a fiber structure that is formed into a tissue construct. By modulating the diameter of the fiber structure, the orientation of the collagen fibrils can be controlled to direct polymerization of the collagen fibrils in a desired manner.

For example, previous studies have shown that microfluidic channels of different diameters can direct the polymerization of collagen fibrils to form fibers that are oriented along the length of the channels, but only at channel diameters of 100 μm or less (Lee et al., 2006). Primary endothelial cells grown in these oriented matrices were shown to align in the direction of the collagen fibers. In another study, Martinez et al. demonstrate that 500 μm channels within a cellulose-bead scaffold can direct collagen and cell alignment (Martinez et al., 2012). By modulating the fiber diameter, the orientation of the collagen fibers within the fiber structure can be controlled. As such, the fiber structures, and the collagen fibers within them, can therefore be patterned to produce tissue constructs with a desired arrangement of collagen fibers, essential for conferring desired biomechanical properties on a 3D printed structure.

### Cell Populations:

In embodiments, the cell population is selected from the group comprising or consisting of a single-cell suspension, cell aggregates, cell spheroids, cell organoids, or combinations thereof. Flow materials in accordance with embodiments of the invention can incorporate any mammalian cell type, including but not limited to stem cells (e.g., embryonic stem cells, adult stem cells, induced pluripotent stem cells), germ cells, endoderm cells (e.g., lung, liver, pancreas, gastrointestinal tract, or urogenital tract cells), mesoderm cells (e.g., kidney, bone, muscle, endothelial, or heart cells), ectoderm cells (skin, nervous system, pituitary, or eye cells), stem cell-derived cells, or any combination thereof.

For example, a flow material can comprise cells from endocrine and exocrine glands including pancreas (alpha, beta, delta, epsilon, gamma), liver (hepatocyte, Kuppfer, stellate, sinusoidal endothelial cells, cholangiocytes), thyroid (Follicular cells), pineal gland (pinealocytes), pituitary gland (somatotropes, Lactotropes, gonadotropes, corticotropes, and thyrotropes), thymus (thymocytes, thymic epithelial cells, thymic stromal cells), adrenal gland (cortical cells, chromaffin cells), ovary (granulosa cells), testis (Leydig cells), gastrointestinal tract (enteroendocrine cells-intestinal, gastric, pancreatic), fibroblasts, chondrocytes, meniscus fibrochondrocytes, bone marrow stromal (stem) cells, embryonic stem cells, mesenchymal stem cells, induced pluripotent stem cells, differentiated stem cells, tissue-derived cells, smooth muscle cells, skeletal muscle cells, cardiac muscle cells, epithelial cells, endothelial cells, myoblasts, chondroblasts, osteoblasts, osteoclasts, and any combinations thereof.

Cells can be obtained from donors from the same species as the recipient (allogenic), from a different species to the recipient (xenogeneic) or from recipients (autologous). Specifically, in embodiments, cells can be obtained from a suitable donor, such as a human or animal, or from the subject into which the cells are to be implanted. Mammalian species include, but are not limited to, humans, monkeys, dogs, cows, horses, pigs, sheep, goats, cats, mice, rabbits, and rats. In one embodiment, the cells are human cells. In other embodiments, the cells can be xenogeneic, e.g., derived from animals such as dogs, cats, horses, monkeys, or any other mammal.

In some embodiments, the at least one biological material comprises a cell population expressing/secreting one or more endogenous biologically active agent(s), e.g., insulin, glucagon, ghrelin, pancreatic polypeptide, Factor VII, Factor VIII, Factor IX, alpha-1-antitrypsin, an angiogenic factor, a growth factor, a hormone, an antibody, an enzyme, a protein, an exosome, and the like. Discussed herein, endogenous biologically active agents comprise those agents that the cell naturally produces in a biological context (e.g., insulin release in response to elevated glucose concentrations). An endogenous biologically active agent can constitute a therapeutic agent in the context of the present disclosure.

In some embodiments, a flow material can comprise genetically engineered cells that secrete specific factors. It is within the scope of this disclosure that a cell population as discussed above can comprise, in embodiments, engineered cells (e.g., genetically engineered cells) that secrete specific factors. Cells can also be from established cell culture lines, or can be cells that have undergone genetic engineering and/or manipulation to achieve a desired genotype or phenotype. In some embodiments, pieces of tissue can also be used, which may provide a number of different cell types within the same structure.

Genetic engineering techniques applicable to the present disclosure can include but are not limited to recombinant DNA (rDNA) technology (Stryjewska et al., Pharmacologial Reports. 2013; 65: 1075), cell-engineering based on use of targeted nucleases (e.g., meganuclease, zinc finger nucleases (ZFN), transcription activator-like effector nucleases (TALEN), clustered regularly interspaced short palindromic repeat-associated nuclease Cas9 (CRISPR-Cas9), etc. (Lim et al., Nature Communications. 2020; 11: 4043: Stoddard BL, Structure. 2011; 19 (1): 7-15; Gaj et al., Trends Biotechnol. 2013; 31 (7): 397-405; Hsu et al., Cell. 2014; 157 (6): 1262; Miller et al., Nat Biotechnol. 2010; 29 (2): 143-148), cell-engineering based on use of site-specific recombination using recombinase systems (e.g., Cre-Lox) (Osborn et al., Mol Ther. 2013; 21 (6): 1151-1159; Hockemeyer et al., Nat Biotechnol. 2009; 27 (9): 851-857; Uhde-Stone et al., RNA. 2014; 20 (6): 948-955: Ho et al., Nucleic Acids Res. 2015; 43 (3): e17: Sengupta et al., Journal of Biological Engineering. 2017; 11 (45): 1-9), and the like. In some embodiments, some combination of the above-mentioned techniques for cell-engineering may be used.

Encompassed by the present disclosure are engineered cells capable of producing one or more therapeutic agents, including but not limited to proteins, peptides, nucleic acids (e.g., DNA, RNA, mRNA, siRNA, miRNA, nucleic acid analogs), peptide nucleic acids, aptamers, antibodies or fragments or portions thereof, antigens or epitopes, hormones, hormone antagonists, growth factors or recombinant growth factors and fragments and variants thereof, cytokines, enzymes, antibiotics or antimicrobial compounds, anti-inflammation agent, antifungals, antivirals, toxins, prodrugs, small molecules, drugs (e.g., drugs, dyes, amino acids, vitamins, antioxidants) or any combination thereof.

### Examples

In the following examples, convolutional neural networks, for both object detection and semantic segmentation, were trained to monitor and analyze different properties of the printhead and biomaterials during gelation and extrusion processes. Several case studies were conducted using the Aspect Biosystems RXI™ bioprinting platform. The examples demonstrate the use of computer vision for detection and valve localization and state detection during operation, segmentation of anomalies and bubbles within the microchannels, and analysis of single material fiber properties, as well as analysis of more complex coaxially layered hydrogel fibers.

To aid in segmenting and identifying the flow of biomaterial through the microfluidic printhead, food dye was used for purposes of the following case study examples and was added to bioink in the bioprinter to enable visual discernment of material boundaries. In order to facilitate bioprinting and microfluidic experiments employing cells and biomaterials, a cell-friendly bioink material that is visible in ambient lighting conditions has also been developed. This material was used subsequently to perform printing experiments with bioinks containing actual cells.

In additional embodiments, it is also possible to segment and identify material flows even when the materials are transparent. As a fiber is formed in the printhead through crosslinking, its edges become more distinguishable due to a difference in refractive index from the surrounding material. Edges of the fiber are imaged while shining a light source directly inline and toward the camera from the opposite side of the nozzle. Distinguishable edges are a relevant feature that can be used to train a machine-learning algorithm to identify the dimensions of the fiber through segmentation.

From these examples and the accompanying discussion, the benefits of computer vision and deep learning to accurately monitor the performance and operation of microfluidic printheads in 3D bioprinters can be appreciated. In particular, it will be appreciated computer vision systems employed with 3D bioprinters enable accurate feedback and contactless sensing, thus enabling future opportunities for closed loop control to achieve performance optimization which otherwise would be impossible.

To prepare for the case studies, preliminary work was done to identify and to train neural networks for possible use in the case studies.

Within the context of microfluidic-based 3D bioprinting, in an embodiment valves may be used to control the flow of fluids composed of different biomaterials or cells within the microchannels of a microfluidic printhead. This allows for the use of different fluids, either alone or in combination, to generate complex fiber and tissue structures from a single microfluidic device. When a valve is pneumatically pressurized, all flow is restricted through the microchannel. This corresponds to a closed state. When a valve is pneumatically relaxed, all flow is allowed through the microchannel. This corresponds to an open state. In an embodiment, the valve may be configured so that when it is pneumatically relaxed, the valve is closed, and when pneumatically pressurized, the valve is open.

Because microfluidic devices are typically made from transparent materials, there is a visible change in valve appearance due to the expansion of the walls when they open and close. Because of this visible change, computer vision can detect valve operational states through monitoring of the valves' physical appearance during operation.

Object detection networks can be used not only to classify different objects, but also to localize them within a larger image. The following examples show the results of an evaluation of an embodiment of a computer vision and deep learning system to detect and monitor the operational state of each valve within a microfluidic printhead. For purposes of the following examples, already established convolutional neural networks were selected.

For real-time detection, inference speed is important. Accordingly, for purposes of the following examples, the single shot detector (SSD) was the selected meta-architecture. When implementing a single shot detector network, the feature extractor can vary depending on the application and the type of objects that need to be detected. Selecting the most suitable feature extractor often comes down to evaluating different networks for their performance.

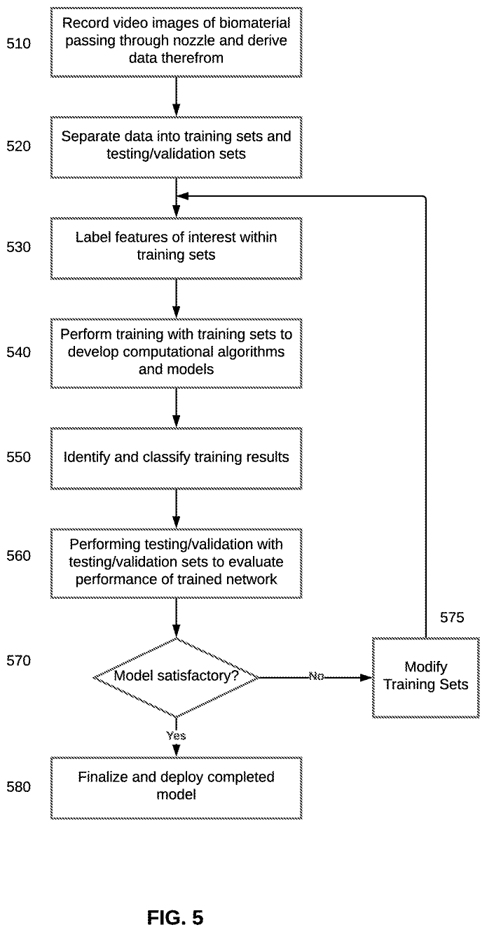

Valve localization and state detection were accomplished using an object detection convolutional neural network. Videos of an Aspect Biosystems DUO™ microfluidic printhead were collected on the Aspect Biosystems RXI™ bioprinter while in operation using the built-in camera to generate a dataset for training and evaluation. Videos were recorded at 480p and frames were extracted for labelling. Valves were individually labelled based on their location and if they were open or closed. An example of labelled images can be seen in FIGS. 6A and 6B. FIG. 6A shows bounding boxes around the valves in the printhead. FIG. 6B shows the same bounding boxes, with further identification of the open or closed state of the valves. FIGS. 6C and 6D show a running estimate of operational states of valve 1 and valve 2, respectively, during a printing session. In this example, valve 1 was opened for approximately three seconds to generate a fiber. Valve 2 remained closed.

Data augmentation was conducted by introducing randomized contrast, brightness, and reflections to increase the size and variety of images used for training. The resulting images were split into two datasets. The first training dataset, with approximately 1500 images, was used to train the object detection network. The second training set, with approximately 250 images, was a validation dataset used to evaluate the trained network's performance prior to deployment.

Three Single Shot Detector (SSD) neural networks, SSD-MobilenetV2, SSD-InceptionV2, and SSD-ResNet50, were trained to determine the most suitable one for deployment. To aid in training, pretrained parameter weights on a common object in context (COCO) dataset were used as an initial training point. A training loss function was comprised of two components. The first component was a Smooth L1 localization loss to quantify the localization error between the predicted and ground truth bounding boxes. This can be seen in Eq. (1) and Eq. (2):

$${L}_{loc} = {smooth}_{L 1} ( {x}_{t} - {x}_{p} ) \qquad ( 1 )$$

$${smooth}_{L 1} ( x ) = {x}^{2} , \qquad ( 2 )$$

$$\vert x \vert$$

$$< 1 \vert x \vert ,$$

$$otherwise$$

In these equations, xₜ corresponds to the min/max coordinates for the ground truth bounding box for a specific object, and xₚ corresponds to the min/max coordinates for the predicted bounding box from the SSD network.

The second component was a weighted focal loss to quantify the error regarding the class prediction corresponding to the proposed bounding box. The equation for the weighted focal loss can be seen in Eq. (3):

$${L}_{class} = - {{α}_{t} ( 1 - {p}_{t} )}^{γ} log ( {p}_{t} ) \qquad ( 3 )$$

In Eq. (3), pₜ corresponds to the SSD network output for the correct class. γ is used to control the modulating factor, (1−pₜ). αₜ is a class weighting scale that is defined by the user to emphasize the detection of certain classes. For training, γ was set to 2 and αₜ was set to 0.75 for positive classes (i.e. opened and closed valve states) and 0.25 for negative classes (ie. background class predictions). The final loss, utilizing both the localization and classification loss functions can be seen in Eq. (4).

$$L = {L}_{loc} + {L}_{class} \qquad ( 4 )$$

Network training was done using the Adam optimizer, as described in Kingma, Diederik & Ba, Jimmy. Adam: A Method for Stochastic Optimization, International Conference on Learning Representations (2014), incorporated herein by reference. All three of the above-mentioned neural networks were evaluated by determining their classification and localization accuracy on the validation dataset. Classification accuracy was determined using Eq. (5):

$$Accuracy = \frac{TP + TN}{TP + TN + FP + FN} \qquad ( 5 )$$

The accuracy is based on the true positives (TP), true negatives (TN), false positives (FP), and false negatives (FN) for each class. Localization accuracy was determined by calculating the Intersection over Union (IoU) scores for correct predictions. IoU is defined as the area of the intersection of the predicted bounding box (xₚ) and ground-truth box (xₜ) divided by the area of their union, as shown in Eq. (6):

$$IoU = \frac{Area ( {x}_{p} ⋂ {x}_{t} )}{Area ( {x}_{p} ⋃ {x}_{t} )} \qquad ( 6 )$$

The loss used for training was a pixel-wise cross entropy loss function. To compute the loss, the final activation values from the UNET network were converted to probability scores corresponding to each class. This was done using the soft max function which can be seen in Eq. (7) for a network that identifies K classes.

$$S ( {p}_{t} ) = \frac{{e}^{{p}_{t}}}{{\sum }_{j = 1}^{K} {e}^{{p}_{j}}} \qquad ( 7 )$$

In Eq. (7), pₜ is the activation value for the t^{th} class for a specific pixel in an image. The soft max function is used to process the activation values from the UNET network for each pixel.

The categorical cross entropy was calculated as shown in Eq. (8).

$${L}_{CE} = - {α}_{p} \sum log ( S ( {p}_{t} ) ) \qquad ( 8 )$$

In Eq. (8), pₜ is the activation value for the true class for a specific pixel. The activation values for the other classes are not taken into consideration. αₚ is a class weight to rescale the loss to penalize misclassifying certain classes. The weights used for training were 1, 1.235, and 1.35 for the background, fiber, and bubbles respectively. The cross-entropy loss was used to quantify the error between the true and predicted classes for all pixels that comprise the image. The Adam optimizer, mentioned above, was used to train the network and minimize the loss function.

The trained UNET network was evaluated on the validation dataset by calculating both the mean IoU and mean F1 scores over all classes. The IoU score was calculated via Eq. (5) and the F1 score was calculated via Eq. (9).

$${F}_{1} = 2 \times \frac{( Precision \times Recall )}{Precision + Recall} \qquad ( 9 )$$

Precision and recall were calculated for each class as seen in Eq. (10) and Eq. (11).

$$Precision = \frac{TP}{TP + FN} \qquad ( 10 )$$

$$Recall = \frac{TP}{TP + FN} \qquad ( 11 )$$

All three networks were trained on the same dataset, and then were examined on a validation dataset to evaluate their performance and determine which is most suitable for deployment.

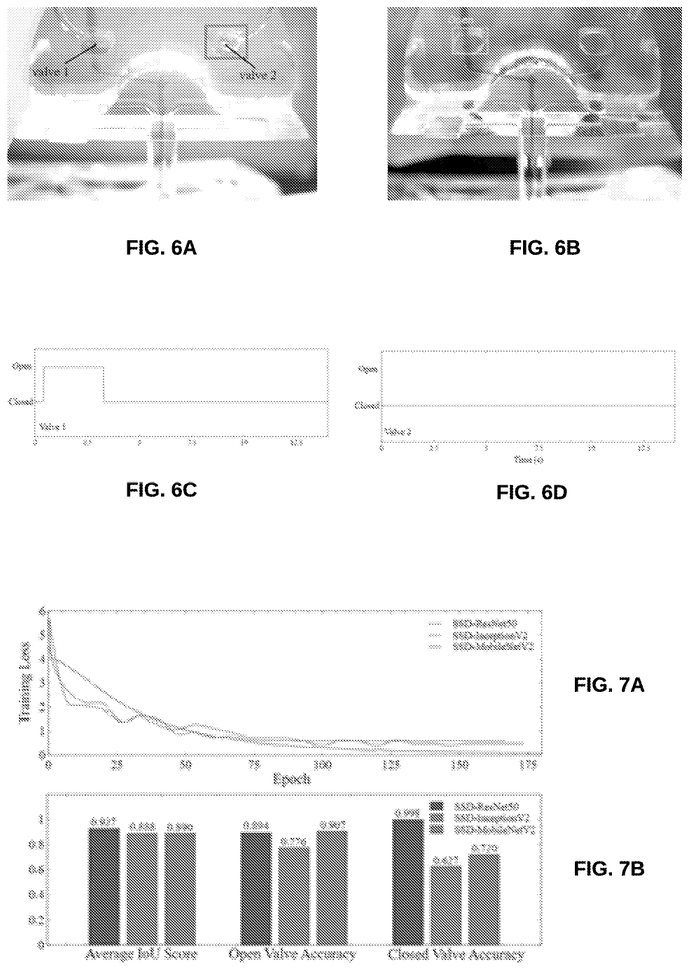

The training results, classification accuracy for both valve states, as well as the average IoU score for correct classifications can be seen in FIGS. 7A and 7B.

Classifications were considered correct if the IoU score was 0.5 or higher. Localization and open valve classification accuracy were very similar in all three networks. However, SSD-ResNet50 had the best accuracy when classifying the closed valve state. SSD-ResNet50 was also able to minimize the loss function without overfitting the best as seen by the training curves. Accordingly, based on the results, it was determined the SSD-ResNet50 network had the best performance of the three. Other non-limiting examples of CNNs that may be useful here include ImageNet, COCO, Cityscapes, PASCAL VOC and ADE20K, as well as MSRF-Net, UACANet-L, ResUNet+++TTA, UNETR, SwinUnet, Unet++, DC-UNET, and KiU-Net.

### Example 1-Single-Material Fibers

For this example, a 3D bioprinting system employing an Aspect Biosystems DUO™ microfluidic printhead was employed.

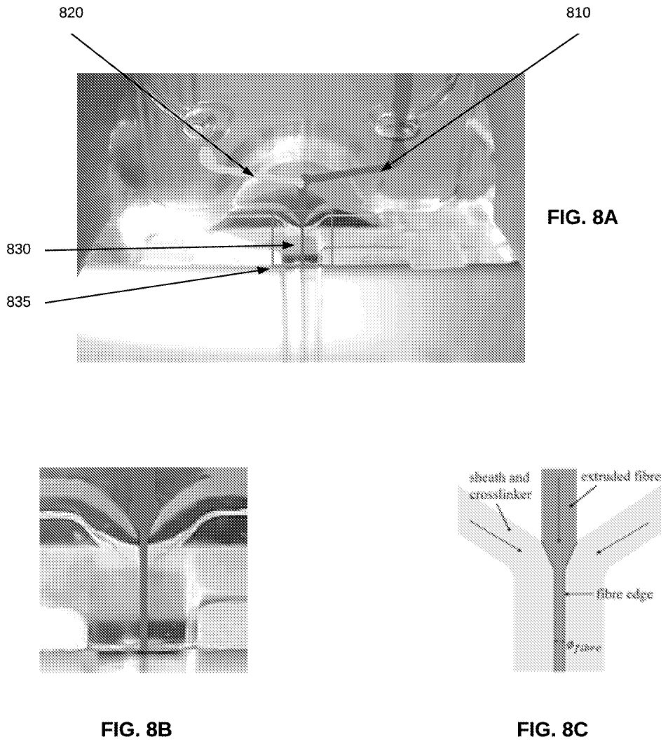

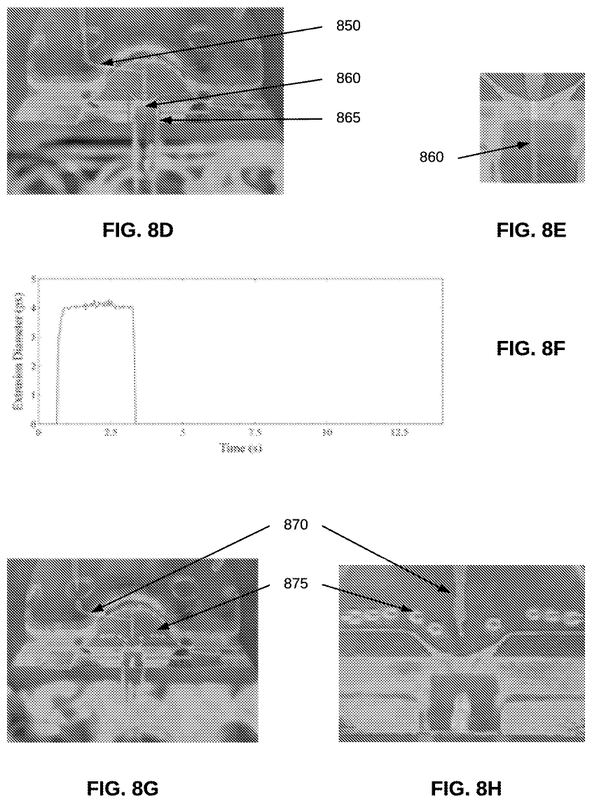

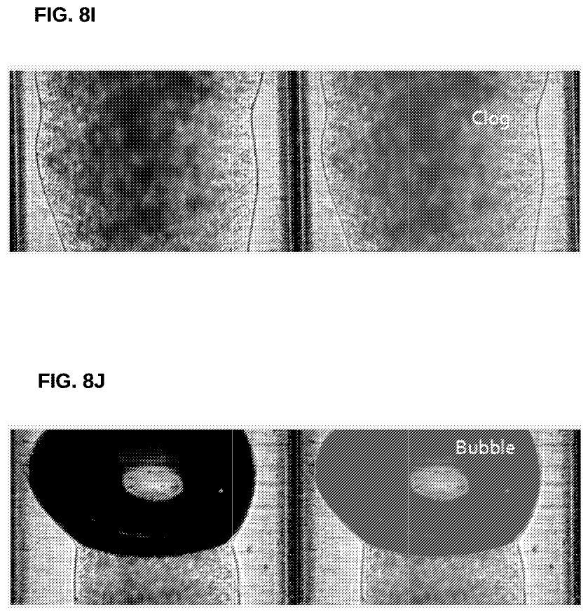

To conduct single material fiber analysis as well as anomaly detection, a semantic segmentation network was utilized to localize the flow of biomaterial and bubbles in the microfluidic printhead during operation. The segmentation network used for this case study was the UNET network. The dataset for fiber analysis and anomaly detection was created using the same videos and images captured for valve state detection, as was described above with reference to FIGS. 6A-6D. In this case, however, pixels were labelled if they correspond to a specific biomaterial or bubbles within the printhead. The rest of the pixels were labelled as background. FIG. 8A shows an example of a labeled image, showing biomaterial 810 or bubbles 820 in the microchannels. FIG. 8B shows an expanded view of FIG. 8A's printhead extrusion region 830, denoted by bounding box 835. FIG. 8C depicts an approach to calculate fiber diameter by estimating location of edges of an extruded fiber.

The same videos collected to conduct the valve detection and state monitoring discussed above with respect to FIGS. 6A-6D were used to examine the performance of the proposed computer vision system for fiber analysis and anomaly detection. The videos were processed at 30 FPS and a running estimate of the extruded fiber diameter and detection of any bubbles or anomalies in the microchannels of the printhead were recorded for analysis and evaluation.

Images were augmented using randomized reflection, brightness, and contrast. The resulting augmented images were split into training and validation datasets of approximately 900 and 150 images respectively.

FIG. 8D shows two valves. In this particular example, only one valve was open to provide biomaterial from the microchannel associated with that valve. The other valve was left closed because the material in that valve's corresponding microchannel was not of use. FIG. 8D shows segmentations from one frame captured during printing. The frame shows the same structure as in FIGS. 6A and 6B. FIG. 8D shows biomaterial 850. There is an extrusion region 860 with a bounding box 865 drawn around it. FIG. 8E shows a magnified view of the extrusion region 860 in the bounding box of FIG. 8D.

FIG. 8F shows a running estimation of extruded fiber diameter during operation of the system. Correspondingly to FIG. 6C, FIG. 8F shows fiber diameter during an approximately three second period when the valve controlling flow of the biomaterial is open.

Using the biomaterial segmentation results, the geometrical properties of the extruded fiber, including the diameter, were monitored and determined. This process was accomplished by estimating edge boundaries of the segmented biomaterial in the extrusion region. Once the edge boundaries were determined, the fiber diameter was calculated based on the average distance between the fiber edges. The estimation then was converted from pixels to microns using a pre calibrated gain based on the position of the camera relative to the printhead.

During printing, the biomaterial fiber was extruded for approximately three seconds. Using segmentation results in the extrusion region, the fiber diameter was estimated to be approximately 4 pixels. To evaluate the accuracy and validity of the computer vision system for fiber analysis, the printed fibers were measured under a microscope after each print session. The measured fiber diameter was then compared with the estimated diameter from the computer vision system. The fiber diameter was estimated with a high degree of accuracy.

The diameter of the extruded fiber is a critical property that directly impacts the final quality of a printed tissue, and so needs to be monitored carefully. Instability and drift in fiber diameter can lead to poor print quality, unpredictable results, and unwanted sample to sample variations. Using an embodiment of the inventive computer vision system, end to end latency of the computer vision system ranged from 23 to 28 ms, enabling the kind of high frame rate necessary for real-time analysis.

In addition to presence and flow of biomaterial in the microfluidic printhead, other factors such as the presence of foreign materials or anomalies in the printhead's microfluidic channels can affect the final quality of the printed structure. Agglomerates of cells and biomaterials can clog the channels in the printhead, thus restricting fluid flow: Bubbles that occur due to dissolved gases in the biomaterial and cells can also interfere with the bioink during extrusion. In many cases, these bubbles tend to remain in the inactive channels. In some cases, however, bubbles can nucleate and mix with the bioink in active channels. FIG. 8G shows an example of bubbles 875 interfering with biomaterial 870 and hence with fiber generation. FIG. 8H is a magnified view of the bubble concentration in FIG. 8G.

When this bubble interference occurs, the consistency of the printed biomaterial can be significantly impacted, thus negatively affecting the final tissue quality. In the majority of cases, it is not possible for the naked eye to recognize when bubbles have nucleated and affected the generated fibers, because the bubbles move rapidly and in any event are difficult to distinguish visually. However, a segmentation network enables ready identification and localization of bubbles in the live camera feed, enabling quality control for improved operation and reliability. FIG. 8I shows additional exemplary backlit visible light (left) and corresponding colored overlay (mask, right) images of a clog interfering with fiber generation. FIG. 8J shows additional exemplary backlit visible light (left) and corresponding colored overlay (mask, right) images of a bubble interfering with fiber generation. In embodiments, the machine-learning based system disclosed herein, responsive to images provided by one or more cameras as described herein, can identify clogs, bubbles, and other types of print defects or print faults, as FIGS. 81 and 8J exemplify.

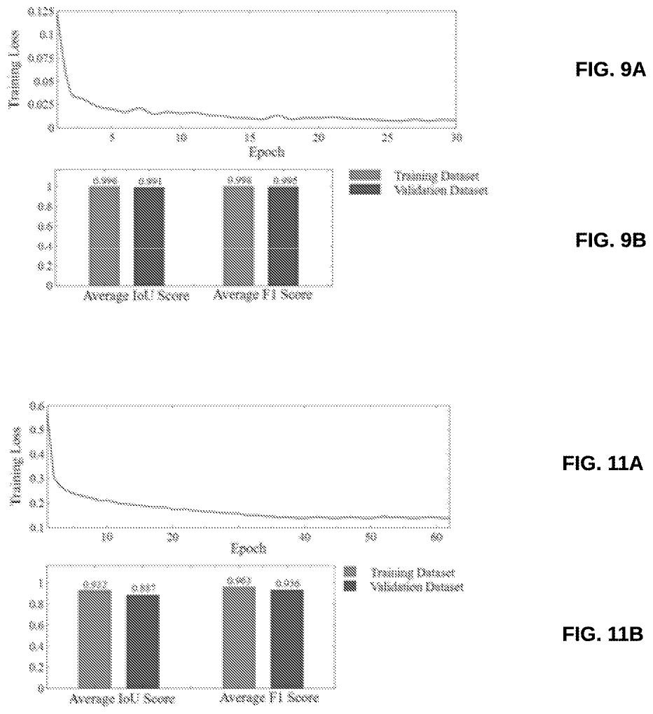

FIG. 9A shows decreased training loss over time. FIG. 9B shows IoU and F1 scores comparing the training and validation datasets used, depicting scores of over 98% and indicating satisfactory performance for the trained network. Weighted classes were necessary to compensate for a significant class imbalance during training because of the large number of background pixels in all of the images.

### Example 2-Coaxially-Layered Hydrogel Fibers

Coaxially layered fibers can be part of complex biological tissue, and can be composed of distinct regions containing different biomaterials, cells, and growth factors, with strict requirements on structural geometry in order to ensure acceptable final tissue quality and function.

For this example, a UNET network, as used in the previous case study, was also used to segment and analyze the geometric properties of more complex coaxially layered fibers generated from a 3D bioprinting system employing an Aspect Biosystems CENTRA™ microfluidic printhead, which enables formation of coaxially layered or hollow perfusable fibers. Such fibers enable 3D patterning of tissues with integrated perfusable vascular structures, and also enable engineered separation of core fiber cells from the external environment.

In this example, a red dyed coaxially layered fibrinogen solution was printed, and the resulting extruded fiber was analyzed at 15 Hz. End to end latency of the computer vision system ranged from 14 to 16 ms. This low latency was made possible using inference acceleration libraries such as Nvidia's TensorRT library as well as GPU accelerated hardware specialized for deep learning, exemplified by the Nvidia Jetson Xavier system.

By simultaneously processing orthogonal projections of the nozzle, it was possible to generate a cross-sectional profile of a bioprinted fiber to provide good visualization of the extruded fiber in real-time. The cross-sectional profiles were used to qualitatively analyze the fiber's axial symmetry, as well as to identify any potential failures or misalignment that can lead to poor structural fidelity and inhomogeneities among multiple print samples.

To achieve the desired biological function, e.g. controlled perfusion when printing coaxially layered biomaterial, the diameter and layer thickness of the shell and core, as well as the concentricity of the core within the shell are critical. The described computer vision system according to embodiments can be fully integrated into a 3D printing platform for real-time analysis of various geometrical properties of the extruded fiber to detect any misalignments and malfunctions that can affect final tissue quality. Furthermore, the computer vision system enables contactless feedback and once again enables opportunities to develop a closed-loop controller that would otherwise be impossible to achieve.

In this example, videos at 1080p were recorded of the nozzle on the printhead while the fiber was being formed and extruded. Images were extracted from the videos, and pixels were labelled as either corresponding to the core material, shell material, or background. Images were then cropped to create 256 by 256-pixel images focused around the fiber. Images were once again augmented through randomized brightness, contrast, and reflection. A training set of approximately 2000 images and a validation dataset of approximately 500 images were obtained.

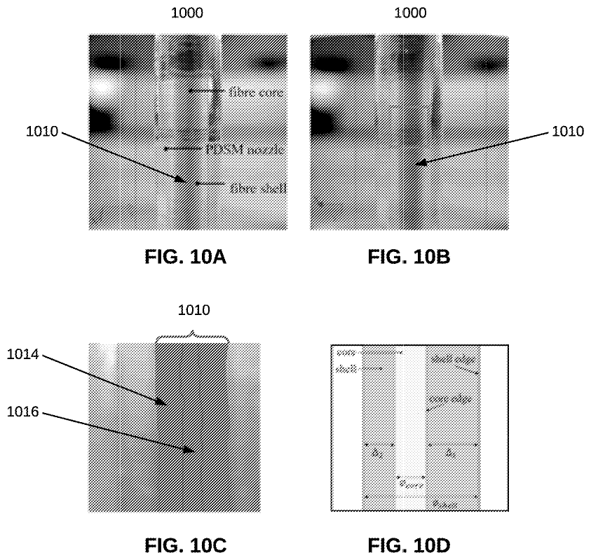

FIGS. 10A and 10B show an image of a printhead nozzle 1000 with a coaxially-layered hydrogel fiber 1010. FIG. 10C highlights shell biomaterial 1014 and core biomaterial 1016 in fiber 1010. FIG. 10D depicts various parameters involved in calculating a degree of misalignment, or misconcentricity, between a central axis of a core and a central axis of a shell in a coaxial bioprinted fiber. The calculation takes into account, among other things, a diameter of the core and a diameter of the shell, and distances of respective sides an outer circumference of the core from an outer circumference of the shell.

A loss function for training was the same pixel-wise categorical cross entropy function shown in Eq. (6). The soft max function, as shown in Eq. (5), also was used to process the activation outputs from the UNET network. Class weights implemented for training were 1, 1.15, 1.25 for the background, shell material, and core material, respectively. The Adam optimizer referenced above again was used to train the network.

With the segmentation results, the layer thickness of the shell and core as well as the core alignment within the shell of the fiber were determined by estimating the edge boundaries of the shell and core via analysis of the segmentation results. Using the edge boundaries, the layer thickness of the different materials that comprise the extruded fiber were determined as shown in FIG. 10D. Core alignment, λ, was also calculated using Eq. (12).

$$λ = \frac{{Δ}_{1}}{{Δ}_{2}} - 1 \qquad ( 12 )$$

In Eq. 12, 41 and 42 correspond to the parameters shown in FIG. 10D. A value of 0 corresponds to perfect alignment in the specified viewing plane, while positive and negative values correspond to misalignments to the right and left respectively.

To demonstrate potential integration into a portable platform, the proposed computer vision system was deployed using a Nvidia Jetson Xavier AGX system as the machine-learning engine 240 in FIG. 2. While deployed on the Nvidia system, the trained network was optimized using a library in Nvidia's TensorRT software development kit (SDK) to reduce network latency and improve throughput. Inference and post processing of the segmentation results were performed only on the Nvidia system. Commands via the main computer 250 were sent to the Nvidia system. Data regarding the geometric properties of the extruded fiber were sent back to the main computer via bi directional transmission control protocol (TCP) communication, which FIG. 2 depicts. Two cameras (210 and 215 in FIG. 2) were positioned at right angles to each other around an extrusion nozzle 220. The camera feeds around the extrusion nozzle were collected through USB communication with the Nvidia system and were analyzed simultaneously. The analysis was conducted at 15 FPS. Using geometric properties calculated from both camera feeds, axial symmetry and core concentricity of the fiber were visualized in real-time for better insight on the fiber's overall structural fidelity.

FIG. 10E shows an example of the segmentation results for one of the captured images. Using the segmentation results, the edges and boundaries of the shell and core materials were located, as seen in FIG. 10F. The segmentation network is able to distinguish between the shell materials and the core materials to identify their boundaries with high accuracy and confidence regardless of the fact that the regions are not easily separable by the naked eye.

FIGS. 10G and 10H depict running estimations of the layer thickness and core alignment of an extruded fiber, with FIG. 10G showing diameter as a function of time, and FIG. 10H showing elapsed time. FIG. 10I shows generated cross sectional profiles of the extruded fiber at different stages during operation using the geometric properties depicted in FIG. 10G. FIG. 10I shows progressive circularity of the core and the shell cross-sections, and of progressive concentricity of the core and the shell.

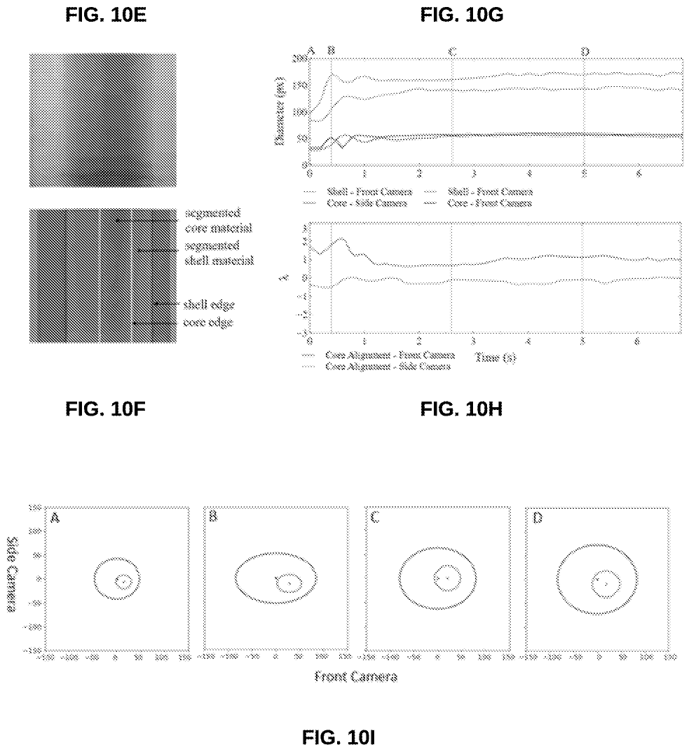

FIG. 11A shows decreased training loss over time. FIG. 11B shows IoU and F1 scores comparing the training and validation datasets used, depicting scores of over 85% and indicating satisfactory performance for the trained network. As noted above, and similarly to the case in Example 1, weighted classes were necessary to compensate for class imbalance during training because of a large proportion of background pixels in the images.

### Example 3-Feedback Control of Fiber Diameter

This Example demonstrates feedback control of a bioprinted fiber comprising a core and a shell, where diameter of the shell is adjusted in real-time to form a bioprinted fiber having a desired shell diameter.

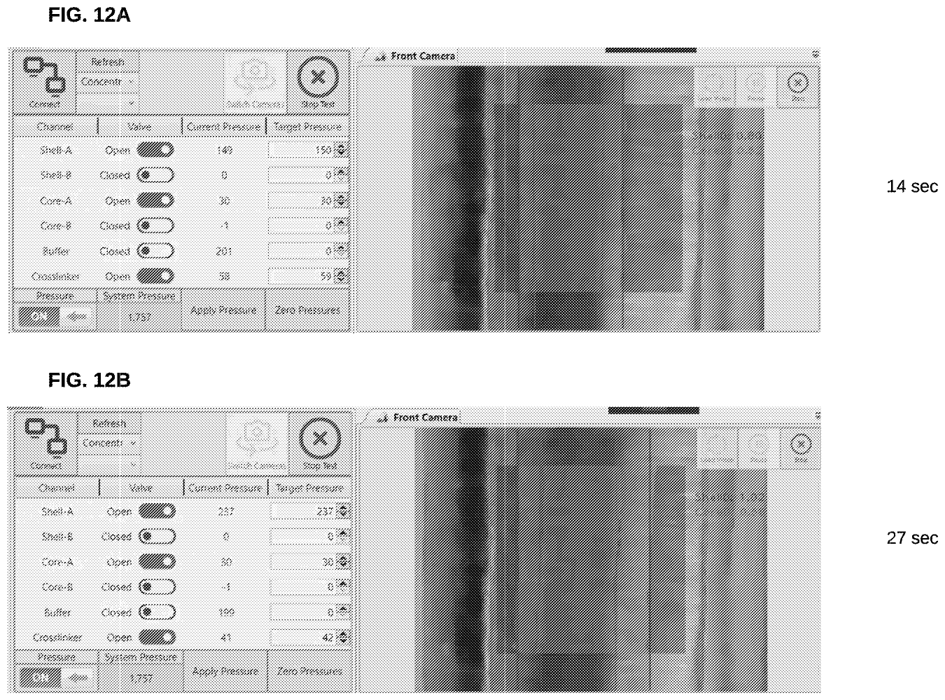

At the beginning of the bioprinting process, the shell outer diameter (OD) and core inner diameter (ID) were set to 1.0 mm and 0.5 mm, respectively. FIG. 12A shows that the machine-learning based system as disclosed herein detected the diameter of the shell to be at 0.80 mm, with pressure for the shell channel at 149 mBar. FIG. 12B shows that the shell channel pressure is adjusted automatically and increased slowly to 237 mBar to increase the diameter of the shell to 1.02 mm over the course of 13 seconds.

### Example 4-Cell Quantity Analysis

This example demonstrates the ability to monitor the approximate cell quantity and/or location in real-time during printing of a biofiber via the systems and methods herein disclosed, enabling qualitative whole-fiber analysis.

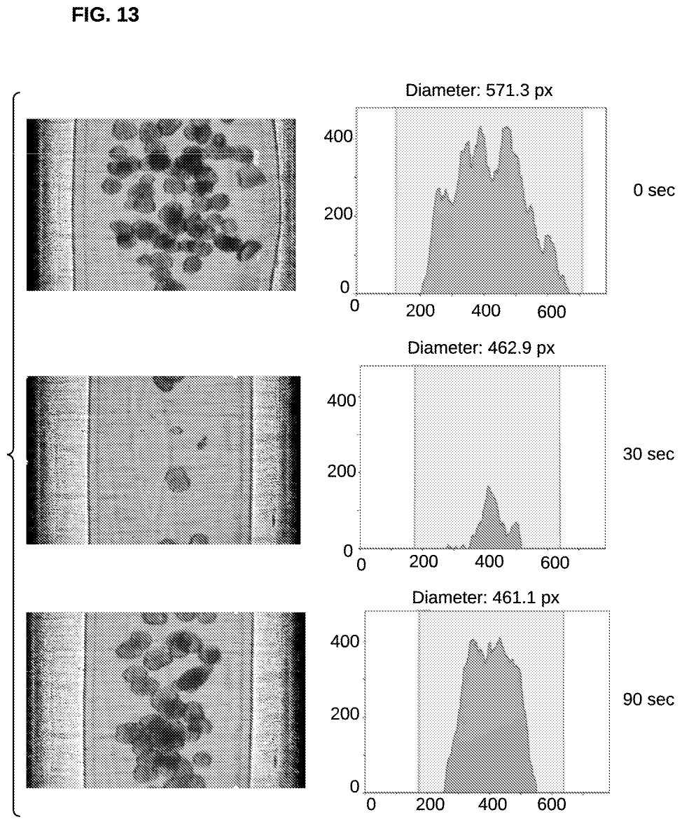

FIG. 13 shows three images and corresponding high-level quantitation of cells in a bioprinted fiber during printing. Each of the images is a representative screenshot taken from an approximately two minute video of a bioprinting process at select time points (0 seconds, 30 seconds, 90 seconds). As can be seen from the images and corresponding cell quantitation, the overall amount of cellular content may fluctuate during the course of the printing process, as a function of various factors. For example, cell quantity is lower at 30 seconds of the printing process as compared to that observed at 0) seconds and 90 seconds. For each of the graphs on the right at FIG. 13, fiber diameter is indicated. The fiber diameter fluctuates in this experiment because closed-loop control was not utilized to control fiber diameter. The x-axis at FIG. 13 corresponds to column number, where each column is the width of one pixel. The y-axis represents sum of pixels in each column in which cellular material is identified. The light orange in the graphs depicts fiber diameter.

The methodology that FIG. 13 exemplifies enables general qualitative analysis of whole fibers containing cellular material. For example, object detection and/or semantic segmentation as implemented in a machine-learning system according to an embodiment enables identification of proximity of cellular material to fiber edges, thereby providing an indication of how centered the cellular material is within a fiber. Fibers for which cellular material is too close to the fiber edge (i.e., cellular material that butts up against the fiber edge) may be rejected for use, because of potential immune system recognition of the cellular material. Additionally or alternatively, object detection and/or semantic segmentation as implemented in a machine-learning system of the present disclosure enables identification of fibers that have degraded cellular quantity in the form of low quantity throughout the fiber, gaps, or other significant fluctuations in cellular material. In embodiments, object detection and/or semantic segmentation as implemented in a machine-learning system according to an embodiment enables identification of fibers of higher quality, for example those with a more consistent cellular content in terms of location (i.e., how centered the cellular material is with respect to the fiber) and/or cellular quantity (i.e., substantial absence of gaps or other fluctuations) throughout a fiber.

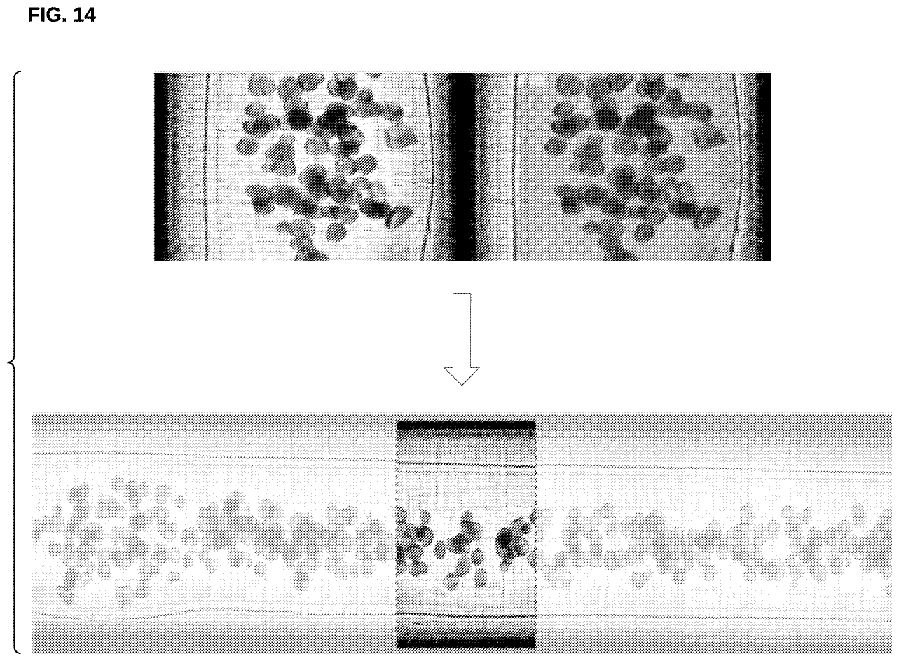

FIG. 14 shows additional qualitative analysis, with exemplary backlit visible (left) and corresponding colored overlay (mask, right) images (top) of a segment of a bioprinted fiber during printing, said segment indicated by the dashed box (bottom). As can be seen in the bottom image, cellular content is substantially consistent throughout the fiber portion shown. In an embodiment, object detection and/or semantic segmentation as implemented in a machine-learning system according to an embodiment enables this type of qualitative analysis as well.

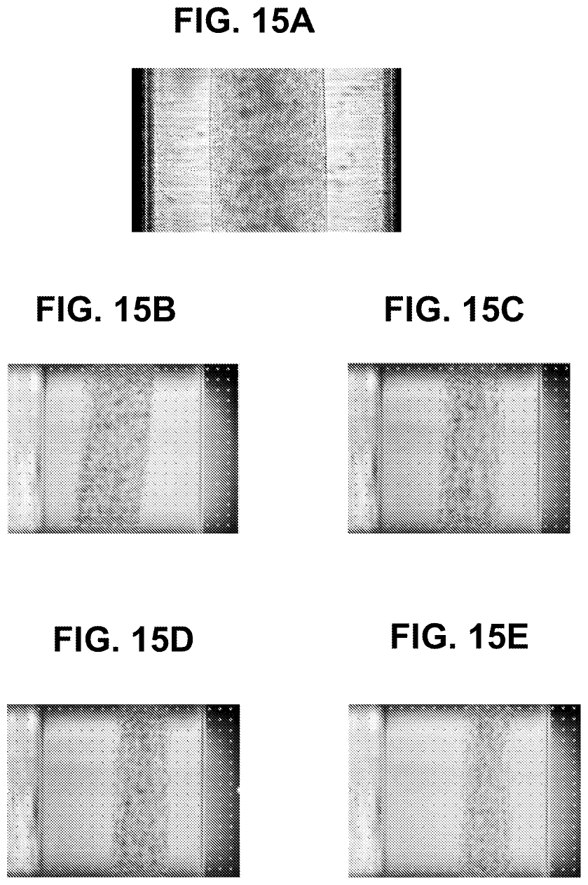

FIG. 15A shows an image of a core and a shell from one camera view according to an embodiment. The image shows the core centered in the shell along one axis. In an embodiment, a corresponding image from another camera view can show the core relative to the shell along another axis, enabling determining of concentricity of the core within the shell. FIGS. 15B-15E are images of different core positions within a shell, the images being taken at successive times as material (such as bio-ink) flows through the print head. The successive images, or indeed a stream of images, can show cell tracking as a velocity vector field. This approach can provide a flow estimation from one or more of the cameras, wherein the flow estimation can be used to measure fiber quality print time. This flow estimation can be used to ensure correct flow (for example, flow in the right direction, or flow that is not stalled for some reason). In embodiments, the flow estimation can be used to help determine whether there is homogeneous flow (as might be reflected in an image of the core and shell), centering of cellular material within the fiber, and/or to help estimate print flow overall.

All patent and non-patent references cited in the present specification are hereby incorporated by reference in their entirety and for all purposes.

1. A microfluidic crosslinking printhead material flow sensing system comprising:
a microfluidic crosslinking printhead;
a camera system to monitor material flow through the microfluidic crosslinking printhead and to provide streaming images of the material flow, the material flow comprising at least one cross-linkable material, preferably wherein said at least one cross-linkable material comprises a hydrogel; and
a computer system to determine physical properties of a printed fiber, resulting from crosslinking created by the material flow, by analyzing the material flow as represented in the streaming images;
wherein the computer system comprises a machine-learning based system that compares the streaming images of the material flow to user-established material flow parameters corresponding to the physical properties of a printed fiber within a predetermined tolerance, and records the material flow parameters for the material flow, and results of the comparison.

2. The system of claim 1, wherein the microfluidic crosslinking printhead comprises one or more transparent channels, and the camera system monitors material flow through at least one of the one or more transparent channels, preferably wherein the microfluidic crosslinking printhead comprises a transparent nozzle or dispensing channel.

3. The system of claim 1 or claim 2, wherein the camera system comprises a first camera positioned at a first angle with respect to the at least one of the one or more transparent channels and a second camera positioned at a second, different angle with respect to the at least one of the one or more transparent channels.

4. The system of claim 3, wherein the first camera and the second camera are at right angles with respect to each other.

5. The system of claim 1 or claim 2, wherein the camera system comprises a camera and a plurality of mirrors, the mirrors positioned to provide a first view and a second, different view with respect to the at least one of the one or more transparent channels, the camera receiving images of the first and second views.

6. The system of claim 5, wherein the second view is orthogonal to the first view.

7. The system of claim 5 or claim 6, wherein the plurality of mirrors comprise three mirrors, arranged to provide the first and second views.

8. The system of claim 3 or 4, wherein the microfluidic system comprises a plurality of transparent channels and the camera system comprises an equal plurality of pairs of first and second cameras, each first and second camera in each pair being positioned at right angles with respect to each other, and each of the plurality of pairs of first and second cameras to monitor material flow through a different respective one of the plurality of transparent channels.

9. The system of any of the preceding claims, wherein the machine-learning based system identifies one or more deviations in the material flow from the user-established material flow parameters.

10. The system of claim 9, wherein, responsive to the identified one or more deviations, the machine-learning based system identifies whether adjusting the material flow parameters is necessary.

11. The system of claim 9 or 10, wherein the machine-learning based system adjusts the material flow parameters in response to cumulative deviations exceeding a predetermined amount.

12. The system of any of the preceding claims, further comprising adjusting the material flow parameters in order to maintain physical properties of the printed fiber within the predetermined tolerance.

13. The system of any of the preceding claims, wherein the machine-learning based system performs object detection and/or semantic segmentation of the streaming images of the material flow.

14. The system of claim 13, wherein the object detection and/or semantic segmentation enables detection of location of one or more objects within the material flow.

15. The system of claim 14, wherein the object detection and/or semantic segmentation enables visual estimation of a shape, size, and/or amount of the one or more objects within the material flow.

16. The system of any of the preceding claims, wherein the microfluidic crosslinking printhead comprises a three-dimensional (3D) bioprinting printhead, and the system comprises a 3D bioprinting system to produce bioprinted fibers.

17. The system of claim 16, wherein the 3D bioprinting printhead comprises a plurality of channels to selectively provide a respective plurality of materials for the material flow.

18. The system of claim 16 or 17, wherein the physical properties comprise a diameter of the bioprinted fibers.

19. The system of any of claims 16 to 18, wherein the physical properties comprise concentricity of the bioprinted fibers.

20. The system of any of the preceding claims, wherein the material flow further comprises at least one biological material: preferably wherein said at least one biological material comprises a cell population.

21. The system of claim 20, wherein the cell population is selected from the group comprising or consisting of a single-cell suspension, cell aggregates, cell spheroids, cell organoids, or combinations thereof.

22. The system of claim 20 or 21, wherein the material flow further comprises microparticles.

23. The system of any of claims 20 to 22, wherein the material flow further comprises dyes, pigments or colloids.

24. The system of any of claims 20 to 23, wherein the cell-laden biomaterials flow through the respective channels to produce the bioprinted fibers.

25. The system of any of claims 16 to 24, wherein the bioprinted fibers are coaxially layered hydrogel fibers.

26. The system of any of claims 16 to 25, wherein the bioprinted fibers comprise a core hydrogel material, and a shell hydrogel material around the core hydrogel material, wherein the core hydrogel material is disposed concentrically within the shell hydrogel material within the predetermined tolerance.

27. The system of any of claims 16 to 26, wherein presence of cells in the material flow acts as a contrast agent to facilitate measurement of physical properties of the bioprinted fibers.

28. The system of any of the preceding claims, wherein the computer system uses the results of the comparison to control the material flow by adjusting displacement of material within the microfluidic crosslinking printhead.

29. The system of any of the preceding claims, further comprising a displacement controller responsive to the results of the comparison to control the material flow and displacement of material through the microfluidic crosslinking printhead during printing of the printed fiber.

30. The system of any of the preceding claims, wherein the computer system uses the results of the comparison to control the material flow by adjusting pressure of material flow within the microfluidic crosslinking printhead.

31. The system of any of the preceding claims, further comprising a pressure controller responsive to the results of the comparison to control the material flow and pressures through the microfluidic crosslinking printhead during printing of the printed fiber.

32. The system of any of the preceding claims, wherein the machine-learning based system is selected from the group consisting of a convolutional neural network (CNN), a long short term memory (LSTM) network, a recurrent neural network (RNN), a recurrent convolutional neural network (RCNN) or a combination of an RNN and a CNN.

33. The system of any of the preceding claims, wherein the machine-learning based system comprises a graphics processing unit (GPU).

34. The system of any of claims 3 to 5, further comprising a light emitting diode (LED) or an LED array to illuminate one or more of the transparent channels.

35. The system of claim 34, further comprising one LED or LED array for each of the cameras respectively.

36. The system of claim 34 or 35, wherein each LED or LED array is positioned behind a respective camera.

37. The system of claim 34 or 35, wherein each LED or LED array is positioned on an opposite side of a transparent channel from the respective camera.

38. The system of claim 5 or claim 6, wherein the plurality of mirrors comprise two mirrors, wherein one of the mirrors is rotatable to provide the first and second views alternately to said camera.

39. A method for monitoring material flow through a crosslinking microfluidic printhead, said method comprising:
obtaining, using a camera system, streaming images of material flow through a microfluidic crosslinking printhead, the material flow comprising at least one cross-linkable material, preferably wherein said at least one cross-linkable material comprises a hydrogel; and
determining physical properties of a printed fiber, resulting from crosslinking created by the material flow, by analyzing the material flow as represented in the streaming images, the determining comprising, using a machine-learning based system, comparing the streaming images of the material flow to user-established material flow parameters corresponding to the physical properties of a printed fiber within a predetermined tolerance.

40. The method of claim 39, wherein the obtaining comprises obtaining the streaming images through one or more transparent channels of the microfluidic crosslinking printhead.

41. The method of claim 39 or claim 40, wherein the obtaining comprises positioning a first camera in the camera system at a first angle with respect to the at least one of the one or more transparent channels, and a second camera in the camera system at a second, different angle with respect to the at least one of the one more transparent channels.

42. The method of claim 41, wherein the positioning comprises positioning the first camera and the second camera at right angles with respect to each other.

43. The method of claim 39 or claim 40, wherein the obtaining comprises positioning a camera in the camera system to provide a first view with respect to the at least one of the one or more transparent channels and positioning a plurality of mirrors to provide a second, different view with respect to the at least one of the one or more transparent channels.

44. The method of claim 43, wherein the second view is orthogonal to the first view.

45. The method of claim 43 or claim 44, wherein the positioning comprises positioning three mirrors to provide the second view.

46. The method of any of claims 39 to 45, wherein the comparing comprises identifying one or more deviations in the material flow from the user-established material flow parameters.

47. The method of claim 46, further comprising determining whether the one or more deviations in the material flow exceeds a predetermined amount, and adjusting one or more of the user-established material flow parameters in response to the determining to maintain the physical properties of the printed fiber within the predetermined tolerance.

48. The method of any of claims 39 to 47, wherein the determining further comprises, using the machine-based learning system, performing object detection and/or semantic segmentation of the streaming images of the material flow.

49. The method of claim 48, wherein the object detection and/or semantic segmentation enables detection of location of one or more objects within the material flow.

50. The method of claim 48 or claim 49, wherein the object detection and/or semantic segmentation enables visual estimation of a shape, size, and/or amount of the one or more objects within the material flow.

51. The method of any of claims 39 to 50, wherein the microfluidic crosslinking printhead comprises a three-dimensional (3D) bioprinting printhead, and wherein the obtaining comprises obtaining streaming images through one or more transparent channels in the 3D bioprinting printhead, the 3D bioprinting printhead producing bioprinted fibers.

52. The method of claim 51, wherein the monitoring comprises monitoring a plurality of channels within the 3D bioprinting printhead, the plurality of channels to selectively provide a respective plurality of materials for the material flow.

53. The method of any of claims 39 to 52, wherein the physical properties comprise concentricity of bioprinted fibers.

54. The method of any of claims 39 to 53, wherein the material flow further comprises at least one biological material: preferably wherein said at least one biological material comprises a cell population.

55. The method of claim 54, wherein the cell population is selected from the group comprising or consisting of a single-cell suspension, cell aggregates, cell spheroids, cell organoids, and/or microparticles.

56. The method of claim 54 or claim 55, wherein material in the material flow further comprises dyes, pigments or colloids.

57. The method of any of claims 54 to 56, wherein the bioprinted fibers are coaxially layered hydrogel fibers.

58. The method of any of claims 54 to 57, wherein the bioprinted fibers comprise a core hydrogel material, and a shell hydrogel material around the core hydrogel material, wherein the core hydrogel material is disposed concentrically within the shell hydrogel material within the predetermined tolerance.

59. The method of any of claims 52 to 58, wherein presence of cells in the material flow acts as a contrast agent to facilitate measurement of physical properties of the bioprinted fibers.

60. The method of claim 39, further comprising, responsive to the determining, controlling the material flow to maintain the physical properties of the printed fiber within the predetermined tolerance.

61. The method of claim 60, wherein controlling the material flow comprises controlling displacement of material within the microfluidic device.

62. The method of claim 60, wherein controlling the material flow comprises controlling pressure of the material flow within the microfluidic device.

63. The method of any of claims 39 to 62, wherein the machine-learning based system is selected from the group consisting of a convolutional neural network (CNN), a long short term memory (LSTM) network, a recurrent neural network (RNN), a recurrent convolutional neural network (RCNN) or a combination of an RNN and a CNN.

64. The method of any of claims 39 to 63, wherein the machine-learning based system comprises a graphics processing unit (GPU).

65. The method any of claims 40 to 43, further comprising positioning a light emitting diode (LED) or an LED array to illuminate one or more of the transparent channels.

66. The method of claim 65, further comprising positioning one LED or LED array for each of the cameras respectively.

67. The method of claim 65 or claim 66, further comprising positioning each LED or LED array behind a respective camera.

68. The method of claim 65 or claim 66, further comprising positioning each LED or LED array on an opposite of a transparent channel from the respective camera.

69. The method of claim 43 or claim 44, wherein the positioning comprises positioning two mirrors to provide the first and second views alternately to said camera, wherein one of the mirrors is rotatable to provide the first and second views alternately to said camera.

70. The method of any of claims 39 to 69, further comprising identifying one or more defects in the material flow by analyzing the material flow as represented in the streaming images, using the machine-learning based system to perform object detection and/or semantic segmentation on the streaming images.

71. The method of claim 70, wherein said one or more defects is a clog and/or a bubble.

72. The method of any of claims 39 to 69, further comprising providing a general amount and/or distribution of one or more objects within the material flow, preferably wherein the one or more objects comprises biological materials.

73. The method of any of claims 39 to 72, further comprising analyzing whether the core hydrogel material is disposed concentrically in the shell hydrogel material.
